(19) United States
(12) Patent Application Publication
(10) Pub. No.: US 2023/0004788 A1
(43) Pub. Date: Jan. 5, 2023

(54) HARDWARE ARCHITECTURE FOR PROCESSING TENSORS WITH ACTIVATION SPARSITY

(71) Applicant: Numenta, Inc., Redwood City, CA (US)

(72) Inventors: Kevin Lee Hunter, Sunnyvale, CA (US); Lawrence Spracklen, Boulder Creek, CA (US); Subutai Ahmad, Palo Alto, CA (US)

(21) Appl. No.: 17/856,530

(22) Filed: Jul. 1, 2022

Related U.S. Application Data
(60) Provisional application No. 63/218,354, filed on Jul. 4, 2021.

(51) Int. Cl. G06N 3/063; G06F 7/523

(52) U.S. Cl. CPC G06N 3/063; G06F 7/523

(57) ABSTRACT

A hardware accelerator that is efficient at performing computations related to tensors. The hardware accelerator may store a complementary dense process tensor that is combined from a plurality of sparse process tensors. The plurality of sparse process tensors have non-overlapping locations of active values. The hardware accelerator may perform elementwise operations between the complementary dense process tensor and an activation tensor to generate a product tensor. The hardware accelerator may re-arrange the product tensor based on a permutation logic to separate the products into groups. Each group corresponds to one of the sparse process tensors. Each group may be accumulated separately to generate a plurality of output values. The output values may be selected in an activation selection. The activation selection may be a dense activation or a sparse activation such as k winner activation that set non-winners to zeros.

### CROSS-REFERENCE TO RELATED APPLICATIONS

The present application claims the benefit of U.S. Provisional Patent Application 63/218,354, filed on Jul. 4, 2021, which is hereby incorporated by reference in its entirety.

### FIELD OF THE DISCLOSURE

The present disclosure relates to learning and processing tensors, and more specifically to hardware architecture that is efficient at performing operations related to sparse tensors.

### BACKGROUND

The use of artificial neural networks (ANN), or simply neural networks, includes a vast array of technologies. An ANN's complexity, in terms of the number of parameters, is growing exponentially at a faster rate than hardware performance. In many cases, an ANN may have a large number of parameters. Training and inference on these networks are bottlenecked by massive linear tensor operations, multiplication and convolution. Consequently, a large amount of time and/or resources may be used for both ANN creation (e.g., training) and execution (e.g., inference).

Computing systems that execute ANNs often involve extensive computing operations including multiplication and accumulation. For example, CNN is a class of machine learning techniques that primarily uses convolution between input data and kernel data, which can be decomposed into multiplication and accumulation operations. Using a central processing unit (CPU) and its main memory to instantiate and execute machine learning systems or models of various configurations is relatively easy because such systems or models can be instantiated with mere updates to code. However, relying solely on the CPU for various operations of these machine learning systems or models would consume significant bandwidth of a central processing unit (CPU) as well as increase the overall power consumption.

### SUMMARY

Embodiments relate to an accelerator for performing operations on tensors. The accelerator may include a plurality of multiply circuits configured to perform multiplications between values in a process tensor and values in an activation tensor to generate a plurality of products. The values in the process tensor are associated with tensor identifiers. The accelerator may also include a routing circuit configured to carry over the tensor identifiers of the values in the process tensor to the plurality of products and divide the plurality of products into subsets based on the tensor identifiers. The accelerator may also include a plurality of adder trees coupled to the routing circuit. Each adder tree is configured to receive a subset of the products that are grouped based on the tensor identifiers and accumulate the subset of the products to generate an output value. The plurality of adder trees is configured to generate a plurality of output values. The accelerator may further include an activation circuit coupled to the plurality of adder trees. The activation circuit is configured to select a subset of the output values as winners of an activation selection and set remaining of the plurality of output values as zero.

In some embodiments, the activation circuit is further configured to boost one or more output values of the plurality of output values before the activation selection.

In some embodiments, the one or more output values that are boosted correspond to one or more nodes that are set to zero in a previous cycle of operation.

In some embodiments, the activation circuit is configured to select K output values as a number of output values in the subset that are selected as the winners and each of the tensor identifiers is used to identify one of the sparse process tensors.

In some embodiments, the process tensor is a complementary dense process tensor that is combined from a plurality of sparse process tensors.

In some embodiments, the routing circuit includes an arbiter circuit that controls routing of a product of the plurality of products to one of the adder trees.

In some embodiments, the plurality of output values correspond to a plurality of channel dimension of the activation tensor.

In some embodiments, the activation circuit includes a histogram memory that is configured to build a histogram that represents a distribution of the plurality of output values.

In some embodiments, the activation circuit includes a sorting circuit configured to select the winners from serial bursts of the output values.

In some embodiments, the activation circuit includes a sorting circuit configured to select the winners from the plurality of output values in parallel.

In some embodiments, a computer-implemented method for operating on tensors may include combining a plurality of sparse process tensors to a complementary dense process tensor. The plurality of sparse process tensors have non-overlapping locations of active values. The method may also include performing computations between the complementary dense process tensor and an activation tensor to generate a plurality of products. The method may further include separating the plurality of products into groups, each group corresponding to one of the sparse process tensors.

In some embodiments, a distribution of the active values in at least one of the sparse process tensors are partitioned.

In some embodiments, the computations between the complementary dense process tensor and the activation tensor are performed by elementwise multiplications between values in the complementary dense process tensor and values in the activation tensor.

In some embodiments, separating the plurality of products into groups includes a pre-multiplication re-arrangement of the activation tensor.

In some embodiments, separating the plurality of products into groups includes a post-multiplication re-arrangement of the plurality of products.

In some embodiments, the method may further include accumulating the groups of products to generate a plurality of accumulated values, each accumulated value corresponding to one of the sparse process tensors.

In some embodiments, the method may further include selecting a subset of the plurality of accumulated values as winners of an activation selection of the sparse neural network; and setting remaining of the plurality of accumulated values as zero.

In some embodiments, separating the plurality of products into groups includes flattening the plurality of products in a form of a tensor into a one-dimensional array and re-arranging the one-dimensional array to the groups of products corresponding to the sparse process tensors.

In some embodiments, the plurality of sparse process tensors corresponds to a plurality of nodes of the sparse neural network.

In some embodiments, the method may further include combining a second plurality of sparse process tensors to a second complementary dense process tensor, wherein the plurality of sparse process tensors and the second plurality of sparse process tensors both correspond to nodes in a layer of the sparse neural network.

In some embodiments, an accelerator for performing operations on tensors may include a memory configured to store a complementary dense process tensor. The complementary dense process tensor may be generated from combining a plurality of sparse process tensors that have non-overlapping locations of active values. The accelerator may also include a computation core coupled to the memory. The computation core is configured to perform computations between two or more tensors to generate a product tensor. The two or more tensors include the complementary dense process tensor. The computation core may include a permutation circuit configured to re-arrange values in one of the two or more tensors or in the product tensor to group the values corresponding to one of the sparse process tensors together.

In some embodiments, the computation core may also include a multiply circuit configured to perform multiplications between two or more tensors; and an adder tree configured to accumulate the values corresponding to the one of the sparse process tensors.

In some embodiments, the permutation circuit is located upstream of the multiply circuit.

In some embodiments, the permutation circuit is located downstream of the multiply circuit.

In some embodiments, the permutation circuit is configured to re-arrange the values in an activation tensor, the activation tensor being one of the two or more tensors.

In some embodiments, the permutation circuit is configured to re-arrange the values in the product tensor.

In some embodiments, the active values in the plurality of sparse process tensors are partitioned, and the permutation circuit includes multiple permutation networks, each of the premutation networks is configured to re-arrange the values correspond a partition.

In some embodiments, the permutation circuit includes a network of switches.

In some embodiments, the values corresponding to the one of the sparse process tensors have the same tensor identifier and the permutation circuit is configured to group the values corresponding to the one of the sparse process tensors based on the tensor identifier.

In some embodiments, the accelerator may further include an activation circuit configured to select k winners of outputs of the computation core as values in an output activation tensor.

The features and advantages described in the specification are not all inclusive and, in particular, many additional features and advantages will be apparent to one of ordinary skill in the art in view of the drawings and specification. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The teachings of the embodiments of the present invention can be readily understood by considering the following detailed description in conjunction with the accompanying drawings.

FIG. 1 is a block diagram of a computing device, according to some embodiments.

FIG. 2A is a conceptual diagram illustrating an example architecture of a neural network, according to an embodiment.

FIG. 2B is a block diagram illustrating an example general operation of a node in a neural network, according to an embodiment.

FIG. 2C through 2F illustrates the concept of sparsity in a neural network, according to an embodiment.

FIG. 3 is a block diagram illustrating circuitry and hardware architecture of an example accelerator, according to an embodiment.

FIG. 4A is a conceptual diagram illustrating various examples of sparse tensors, according to an embodiment.

FIG. 4B illustrates several examples of pairings of sparse tensors, according to an embodiment.

FIG. 5A is a flowchart depicting an example process for performing operations related to complementary sparsity techniques in a sparse neural network, according to an embodiment.

FIG. 5B is a conceptual diagram that graphically illustrates a sparse neural network operation using complementary sparsity techniques, according to an embodiment.

FIG. 5C is a conceptual diagram that illustrates complemental sparsity techniques graphically using three 3×3 sparse kernels as an example, according to an embodiment.

FIG. 6A illustrates an example accelerator that performs pre-multiplication permutation, according to an embodiment.

FIG. 6B illustrates an example accelerator that performs post-multiplication permutation, according to an embodiment.

FIG. 6C is a conceptual diagram illustrating complementary sparsity techniques and a post-multiplication routing, according to an embodiment.

FIG. 7A is a conceptual diagram illustrating example circuitry that may be used in the permutation circuit, according to an embodiment.

FIG. 7B is a block diagram that illustrates circuitry that may be used for pre-multiplication routing, according to an embodiment.

FIG. 8 is a conceptual diagram that graphically illustrates a sparse neural network process using sparse activation, according to an embodiment.

FIG. 9 is a conceptual diagram illustrating the fetching of augmented process tensors and multiplications between process tensor values and activation values, according to an embodiment.

FIG. 10A illustrates that elementwise products are serially routed to the appropriate accumulator, according to an embodiment.

FIG. 10B illustrates that elementwise products are routed in parallel to the appropriate adder-trees, according to an embodiment.

FIG. 10C is a block diagram illustrating the structure of an example arbiter circuit, according to an embodiment.

FIG. 10D is a conceptual diagram illustrating a prefix sum block in an arbiter circuit, according to an embodiment.

FIG. 11 is a conceptual diagram illustrating the circuitry of an example activation circuit and approach used for a parallel global K winner approach, according to an embodiment.

FIG. 12A is a block diagram illustrating the sorting circuit for serially processing complementary sparse convolutions.

FIG. 12B is a block diagram illustrating the sorting circuit for parallel processing complementary sparse convolutions.

### DETAILED DESCRIPTION OF EMBODIMENTS

In the following description of embodiments, numerous specific details are set forth in order to provide more thorough understanding. However, note that the present invention may be practiced without one or more of these specific details. In other instances, well-known features have not been described in detail to avoid unnecessarily complicating the description.

A preferred embodiment is now described with reference to the figures where like reference numbers indicate identical or functionally similar elements. Also in the figures, the left-most digit of each reference number corresponds to the figure in which the reference number is first used.

Reference in the specification to “one embodiment” or to “an embodiment” means that a particular feature, structure, or characteristic described in connection with the embodiments is included in at least one embodiment. The appearances of the phrase “in one embodiment” in various places in the specification are not necessarily all referring to the same embodiment.

Some portions of the detailed description that follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to the desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the embodiments include process steps and instructions described herein in the form of an algorithm. It should be noted that the process steps and instructions of the embodiments could be embodied in software, firmware or hardware, and when embodied in software, could be downloaded to reside on and be operated from different platforms used by a variety of operating systems.

Embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. A computer readable medium is a non-transitory medium that does not include propagation signals and transient waves. Furthermore, the computers referred to in the specification may include a single processor or may be architectures employing multiple processor designs for increased computing capability. Various embodiments described may also be implemented as field-programmable gate arrays (FPGAs), which include hardware programmable devices that accept programming commands to execute the processing of input data.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below. In addition, embodiments are not described with reference to any particular programming language. It will be appreciated that a variety of programming languages may be used to implement the teachings as described herein, and any references below to specific languages are provided for disclosure of enablement and best mode of the embodiments.

In addition, the language used in the specification has been principally selected for readability and instructional purposes, and may not have been selected to delineate or circumscribe the inventive subject matter. Accordingly, the disclosure set forth herein is intended to be illustrative, but not limiting, of the scope, which is set forth in the claims.

Embodiments relate to architecture of an accelerator that is efficient at processing tensors associated with a sparse node. A sparse node may include a sparse tensor that has a low density of active values. In using a generic processor, the computation operation of a tensor, sparse or dense, may include computing the value in the tensor one by one. However, in a sparse tensor, since many values in the tensor are inactive (e.g., zeros) and computation with such inactive values can be skipped, the accelerator may determine the locations of active values in the tensor and perform computation efficiently so that the number of operations to process the tensor is reduced. In some embodiments, since the tensors may have a high degree of sparsity, the sparse tensors may be combined into a dense tensor so that computations of multiple tensors may be carried out in a single set of operations. The distribution of the active values in the sparse tensors may be arranged such that the active values among the sparse tensors to be combined are non-overlapping. The combined dense tensor may be referred to as a complementary dense tensor. Circuitry that improves the routing and re-arrangement of elements may be used to improve the efficiency in grouping and separating the active values back to sparse tensors after the combination.

### Example Computing Device Architecture

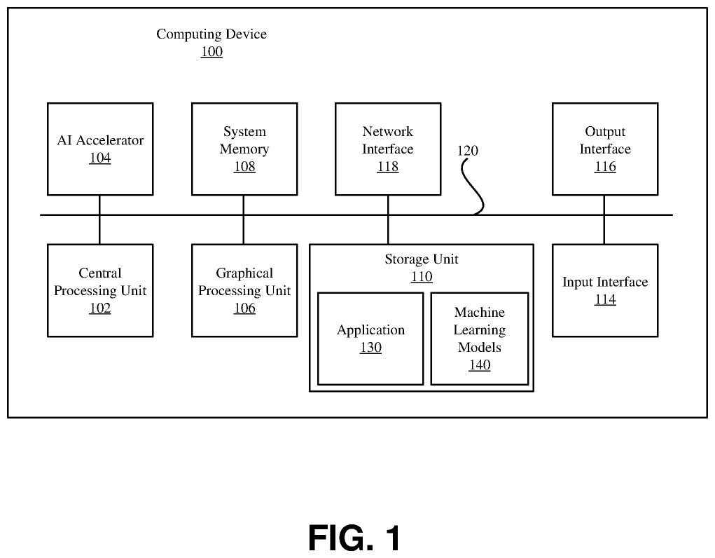

FIG. 1 is a block diagram of an example computing device 100 for processing one or more sparse neural networks, according to an embodiment. A computing device 100 may be a server computer, a personal computer, a portable electronic device, a wearable electronic device (e.g., a smartwatch), an IoT device (e.g., a sensor), smart/connected appliance (e.g., a refrigerator), dongle, a device in edge computing, a device with limited processing power, etc. The computing device 100 may include, among other components, a central processing unit (CPU) 102, an accelerator 104 for performing tensor operations, a graphical processing unit (GPU) 106, system memory 108, a storage unit 110, an input interface 114, an output interface 116, a network interface 118, and a bus 120 connecting these components. In various embodiments, computing device 100 may include additional, fewer or different components. In some embodiments, the accelerator 104 (including examples of accelerators in subsequent figures) may also be referred to as artificial intelligence accelerator (AI accelerator).

While some of the components in this disclosure may at times be described in a singular form while other components may be described in a plural form, various components described in any system may include one or more copies of the components. For example, a computing device 100 may include more than one processor such as CPU 102, accelerator 104, and GPU 106, but the disclosure may refer the processors to as “a processor” or “the processor.” Also, a processor may include multiple cores.

CPU 102 may be a general-purpose processor using any appropriate architecture. CPU 102 retrieves and executes computer code that includes instructions, when executed, that may cause CPU 102 or another processor, individually or in combination, to perform certain actions or processes that are described in this disclosure. Instructions can be any directions, commands, or orders that may be stored in different forms, such as equipment-readable instructions, programming instructions including source code, and other communication signals and orders. Instructions may be used in a general sense and are not limited to machine-readable codes. CPU 102 may be used to compile the instructions and also determine which processors may be used to performed certain tasks based on the commands in the instructions. For example, certain machine learning computations may be more efficient to be processed using accelerator 104 while other parallel computations may be better to be processed using GPU 106.

Accelerator 104 may be a processor that is efficient at performing certain machine learning operations such as tensor multiplications, convolutions, tensor dot products, etc. In various embodiments, accelerator 104 may have different hardware architectures. For example, in one embodiment, accelerator 104 may take the form of field-programmable gate arrays (FPGAs). In another embodiment, accelerator 104 may take the form of application-specific integrated circuits (ASICs), which may include circuits along or circuits in combination with firmware.

GPU 106 may be a processor that includes highly parallel structures that are more efficient than CPU 102 at processing large blocks of data in parallel. GPU 106 may be used to process graphical data and accelerate certain graphical operations. In some cases, owing to its parallel nature, GPU 106 may also be used to process a large number of machine learning operations in parallel. GPU 106 is often efficient at performing the same type of workload many times in rapid succession.

While, in FIG. 1, the processors CPU 102, accelerator 104, and GPU 106 are illustrated as separated components, in various embodiments the structure of one processor may be embedded in another processor. For example, one or more examples of the circuitry of accelerator 104 disclosed in different figures of this disclosure may be embedded in a CPU 102. The processors may also be included in a single chip such as in a system-on-a-chip (SoC) implementation. In various embodiments, computing device 100 may also include additional processors for various specific purposes. In this disclosure, the various processors may be collectively referred to as “processors” or “a processor.”

System memory 108 includes circuitry for storing instructions for execution by a processor and for storing data processed by the processor. System memory 180 may take the form of any type of memory structure including, for example, dynamic random access memory (DRAM), synchronous DRAM (SDRAM), double data rate (DDR, DDR2, DDR3, etc.) RAMBUS DRAM (RDRAM), static RAM (SRAM) or a combination thereof. System memory 108 usually takes the form of volatile memory.

Storage unit 110 may be a persistent storage for storing data and software applications in a non-volatile manner. Storage unit 110 may take the form of read-only memory (ROM), hard drive, flash memory, or another type of non-volatile memory device. Storage unit 110 stores the operating system of the computing device 100, various software applications 130 and machine learning models 140. Storage unit 110 may store computer code that includes instructions that, when executed, cause a processor to perform one or more processes described in this disclosure.

Applications 130 may be any suitable software applications that operate at the computing device 100. An application 130 may be in communication with other devices via network interface 118. Applications 130 may be of different types. In one case, an application 130 may be a web application, such as an application that runs on JavaScript. In another case, an application 130 may be a mobile application. For example, the mobile application may run on Swift for iOS and other APPLE operating systems or on Java or another suitable language for ANDROID systems. In yet another case, an application 130 may be a software program that operates on a desktop operating system such as LINUX, MICROSOFT WINDOWS, MAC OS, or CHROME OS. In yet another case, an application 130 may be a built-in application in an IoT device. An application 130 may include a graphical user interface (GUI) that visually renders data and information. An application 130 may include tools for training machine leaning models 140 and/or perform inference using the trained machine learning models 140.

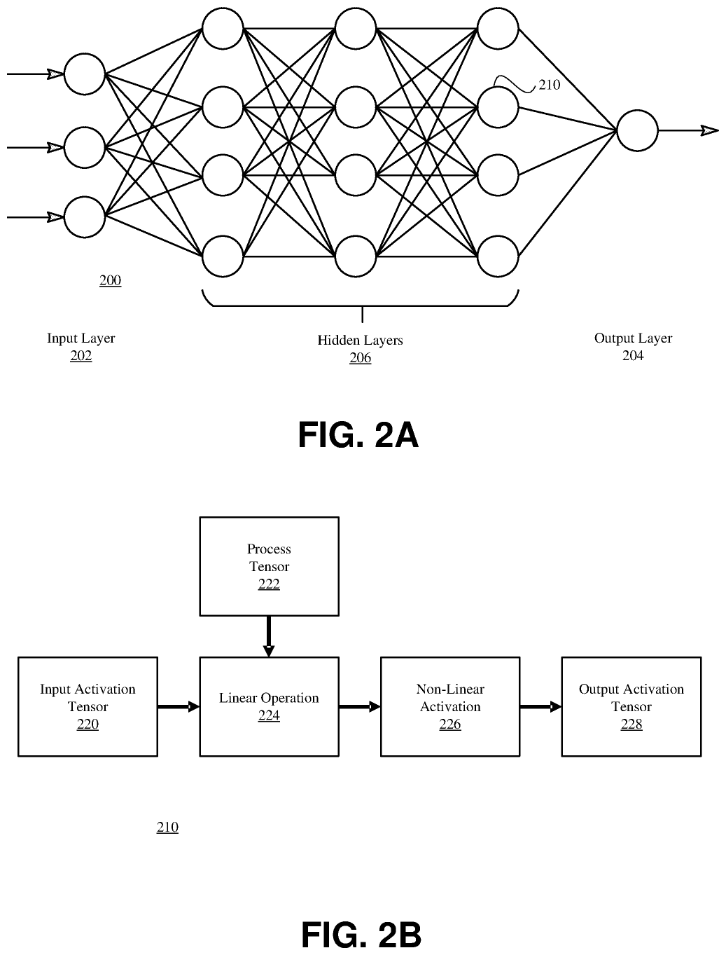

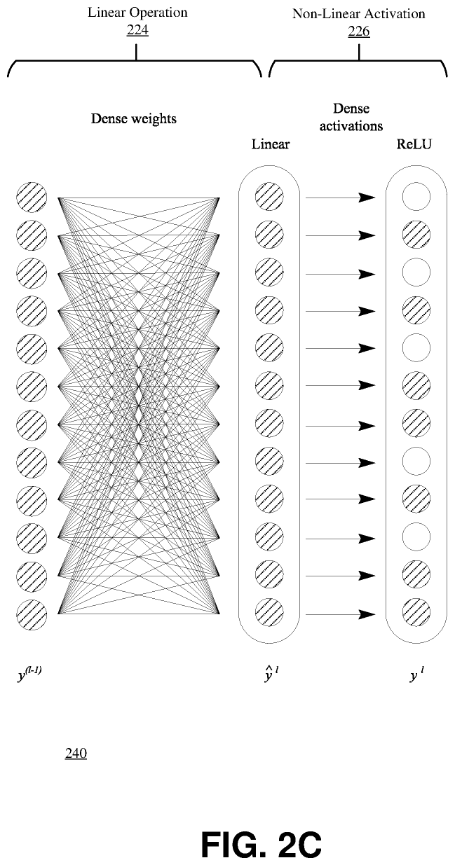

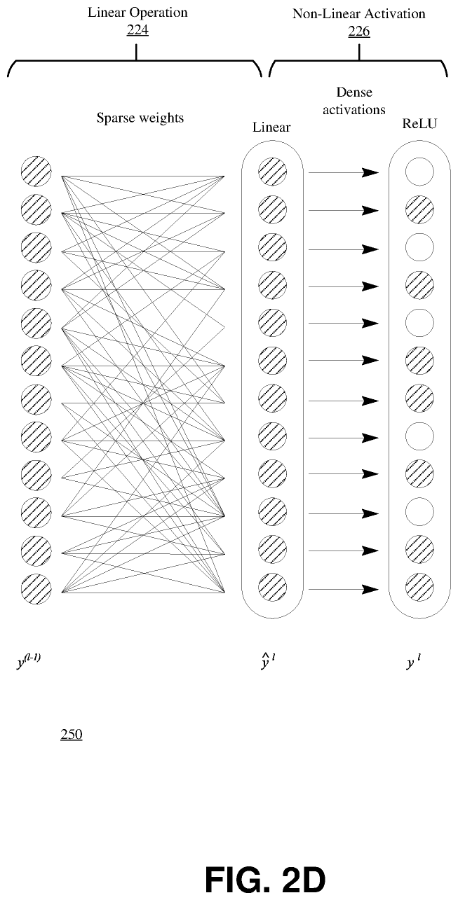

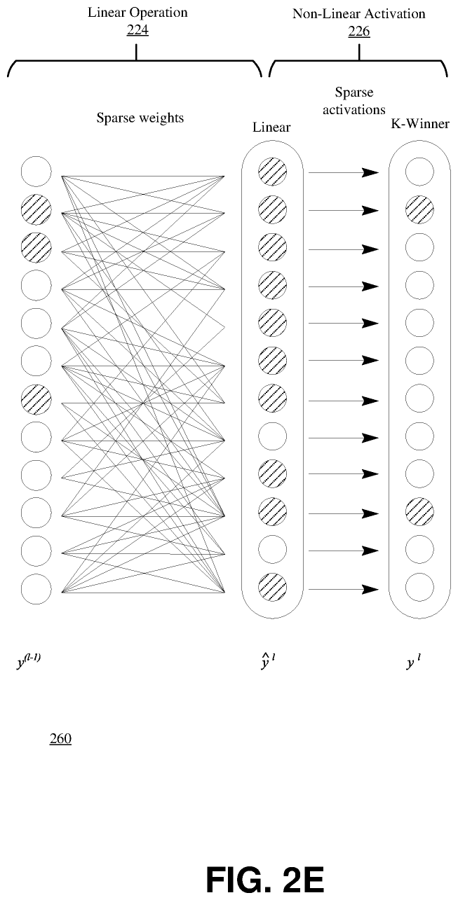

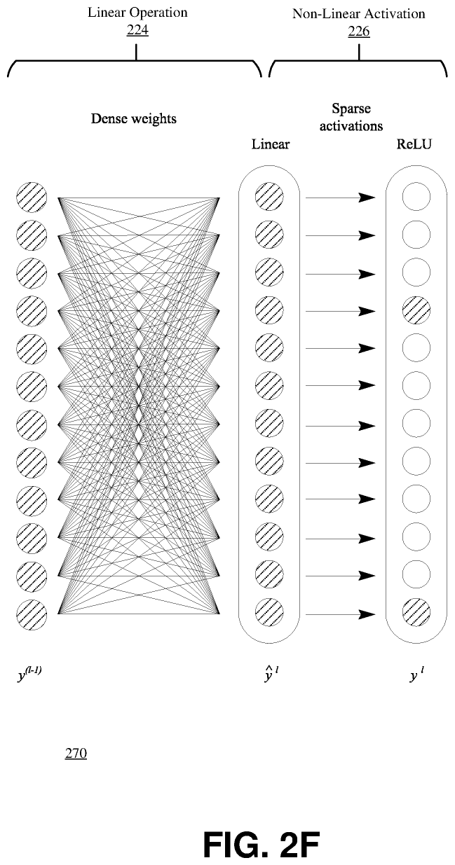

Machine learning models 140 may include different types of algorithms for making inferences based on the training of the models. Examples of machine learning models 140 include regression models, random forest models, support vector machines (SVMs) such as kernel SVMs, and artificial neural networks (ANNs) such as convolutional network networks (CNNs), recurrent network networks (RNNs), autoencoders, long short term memory (LSTM), reinforcement learning (RL) models. Some of the machine learning models may include a sparse network structure whose detail will be further discussed with reference to FIG. 2B through 2D. A machine learning model 140 may be an independent model that is run by a processor. A machine learning model 140 may also be part of a software application 130. Machine learning models 140 may perform various tasks.

By way of example, a machine learning model 140 may receive sensed inputs representing images, videos, audio signals, sensor signals, data related to network traffic, financial transaction data, communication signals (e.g., emails, text messages and instant messages), documents, insurance records, biometric information, parameters for manufacturing process (e.g., semiconductor fabrication parameters), inventory patterns, energy or power usage patterns, data representing genes, results of scientific experiments or parameters associated with the operation of a machine (e.g., vehicle operation) and medical treatment data. The machine learning model 140 may process such inputs and produce an output representing, among others, identification of objects shown in an image, identification of recognized gestures, classification of digital images as pornographic or non-pornographic, identification of email messages as unsolicited bulk email (‘spam’) or legitimate email (‘non-spam’), prediction of a trend in financial market, prediction of failures in a large-scale power system, identification of a speaker in an audio recording, classification of loan applicants as good or bad credit risks, identification of network traffic as malicious or benign, identity of a person appearing in the image, processed natural language processing, weather forecast results, patterns of a person's behavior, control signals for machines (e.g., automatic vehicle navigation), gene expression and protein interactions, analytic information on access to resources on a network, parameters for optimizing a manufacturing process, predicted inventory, predicted energy usage in a building or facility, web analytics (e.g., predicting which link or advertisement that users are likely to click), identification of anomalous patterns in insurance records, prediction on results of experiments, indication of illness that a person is likely to experience, selection of contents that may be of interest to a user, indication on prediction of a person's behavior (e.g., ticket purchase, no-show behavior), prediction on election, prediction/detection of adverse events, a string of texts in the image, indication representing topic in text, and a summary of text or prediction on reaction to medical treatments. The underlying representation (e.g., photo, audio and etc.) can be stored in system memory 108 and/or storage unit 110.

Input interface 114 receives data from external sources such as sensor data or action information. Output interface 116 is a component for providing the result of computations in various forms (e.g., image or audio signals). Computing device 100 may include various types of input or output interfaces, such as displays, keyboards, cameras, microphones, speakers, antennas, fingerprint sensors, touch sensors, and other measurement sensors. Some input interface 114 may directly work with a machine learning model 140 to perform various functions. For example, a sensor may use a machine learning model 140 to infer interpretations of measurements. Output interface 116 may be in communication with humans, robotic agents or other computing devices.

The network interface 118 enables the computing device 100 to communicate with other computing devices via a network. The networks may include, but are not limited to, Local Area Networks (LANs) (e.g., an Ethernet or corporate network) and Wide Area Networks (WANs). When multiple nodes or components of a single node of a machine learning model 140 is embodied in multiple computing devices, information associated with various processes in the machine learning model 140, such as temporal sequencing, spatial pooling and management of nodes may be communicated between computing devices via the network interface 118. Example Neural Network Architecture

FIG. 2A is a conceptual diagram illustrating an example architecture of a neural network 200, according to an embodiment. The illustrated neural network 200 shows a generic structure of a neural network. Neural network 200 may represent different types of neural networks, including convolutional network networks (CNNs), recurrent network networks (RNNs), autoencoders, and long short term memory (LSTM). In various embodiments, customized changes may be made to this general structure. Neural network 200 may also be a hierarchical temporal memory system as described, for example, in U.S. Patent Application Publication No. 2020/0097857, published on May 26, 2020, which is incorporated hereto by reference in its entirety.

Neural network 200 includes an input layer 202, an output layer 204 and one or more hidden layers 206. Input layer 202 is the first layer of neural network 200. Input layer 202 receives input data, such as image data, speech data, text, etc. Output layer 204 is the last layer of neural network 200. Output layer 204 may generate one or more inferences in the form of classifications or probabilities. Neural network 200 may include any number of hidden layers 206. Hidden layer 206 are intermediate layers in neural network 200 that perform various operations. Neural network 200 may include additional or fewer layers than the example shown in FIG. 2A. Each layer may include one or more nodes 210. The number of nodes in each layer in the neural network 200 shown in FIG. 2A is an example only. A node 210 may be associated with certain weights and activation functions. In various embodiments, the nodes 210 in neural network 200 may be fully connected or partially connected.

Each node 210 in neural network 200 may be associated with different operations. For example, in a simple form, neural network 200 may be a vanilla neural network whose nodes are each associated with a set of linear weight coefficients and an activation function. In another embodiment, neural network 200 may be an example convolutional neural network (CNN). In this example CNN, nodes 210 in one layer may be associated with convolution operations with kernels as weights that are adjustable in the training process. Nodes 210 in another layer may be associated with spatial pooling operations. In yet another embodiment, neural network 200 may be a recurrent neural network (RNN) whose nodes may be associated with more complicated structures such as loops and gates. In a neural network 200, each node may represent a different structure and have different weight values and a different activation function.

FIG. 2B is a block diagram illustrating an example general operation of a node 210 in neural network 200, according to an embodiment. A node 210 may receive an input activation tensor 220, which can be an N-dimensional tensor, where N can be greater than or equal to one. Input activation tensor 220 may be the input data of neural network 200 if node 210 is in the input layer 202. Input activation tensor 220 may also be the output of another node in the preceding layer. Node 210 may apply a process tensor 222 to input activation tensor 220 in a linear operation 224, such as addition, scaling, biasing, tensor multiplication, and convolution in the case of a CNN. The result of linear operation 224 may be processed by a non-linear activation 226 such as a step function, a sigmoid function, a hyperbolic tangent function (tanh), rectified linear unit functions (ReLU), or a sparsity activation such as a K-winner take all technique that will be discussed below. The result of the activation is an output activation tensor 228 that is sent to a subsequent connected node that is in the next layer of neural network 200. The subsequent node uses output activation tensor 228 as the input activation tensor 220. Here, the process tensor 222 may be a name for a tensor that includes one or more parameters in an algorithm and the values in the process tensor 222 often include weight values in a machine learning model but are not limited to weights. A process tensor throughout this disclosure may also be referred to as a weight tensor.

In various embodiments, a wide variety of machine learning techniques may be used in training neural network 200. Neural network 200 may be associated with an objective function (also commonly referred to as a loss function), which generates a metric value that describes the objective goal of the training process. The training may intend to reduce the error rate of the model in generating predictions. In such a case, the objective function may monitor the error rate of neural network 200. For example, in object recognition (e.g., object detection and classification), the objective function of neural network 200 may be the training error rate in classifying objects in a training set. Other forms of objective functions may also be used. In various embodiments, the error rate may be measured as cross-entropy loss, L1 loss (e.g., the sum of absolute differences between the predicted values and the actual value), L2 loss (e.g., the sum of squared distances) or their combinations.

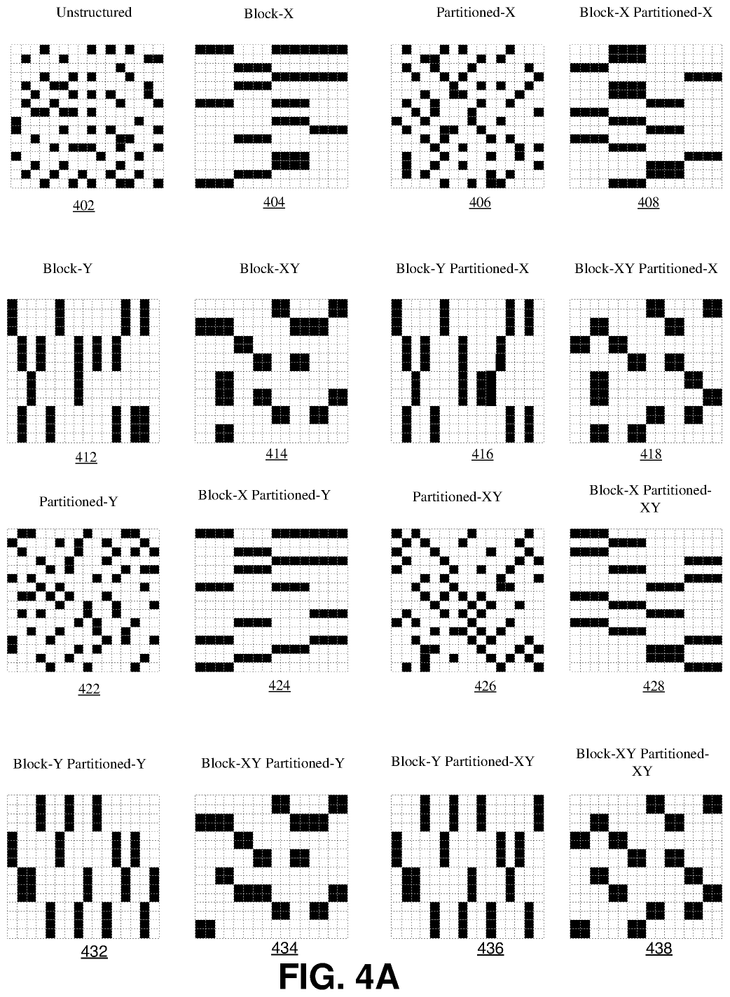

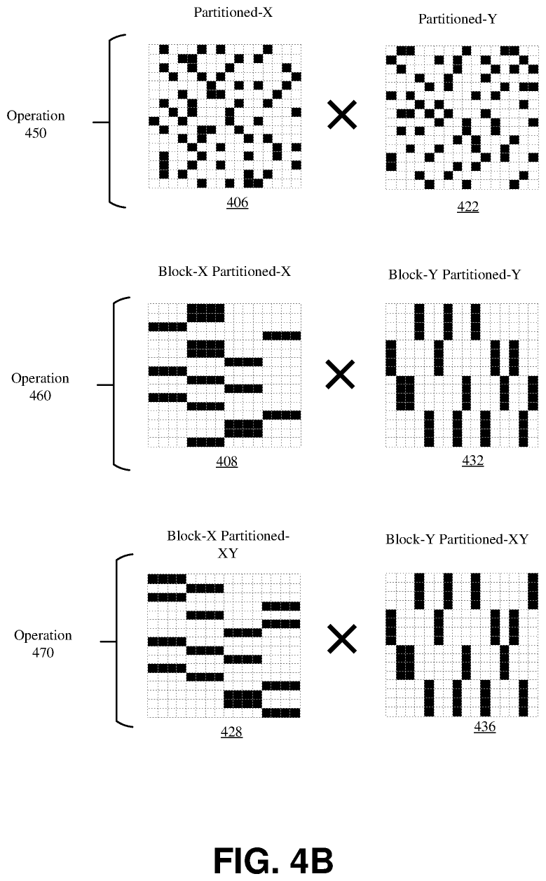

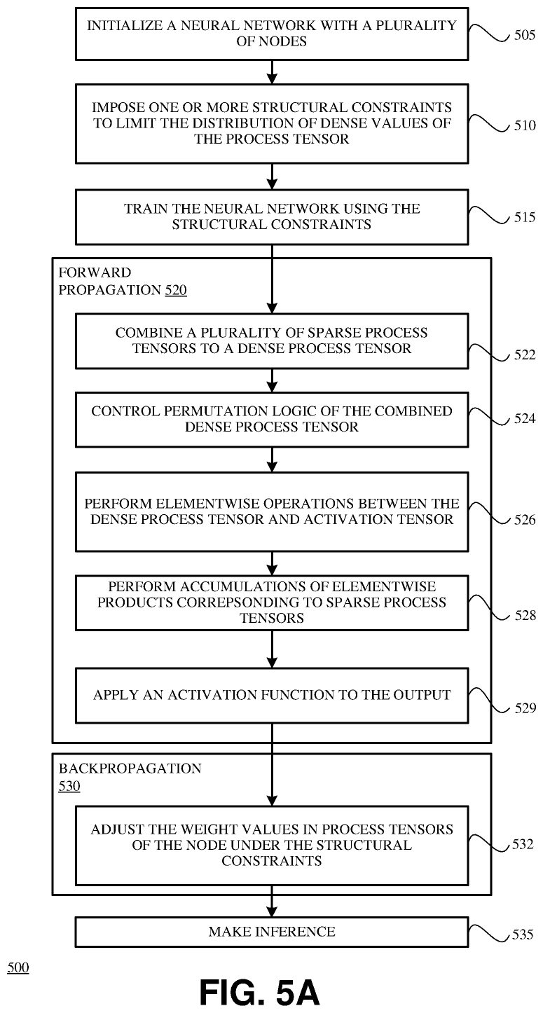

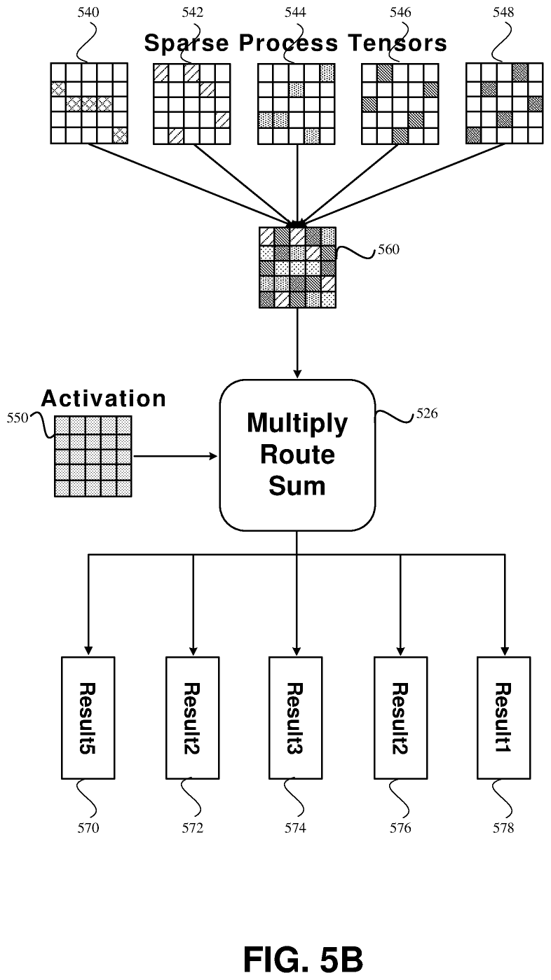

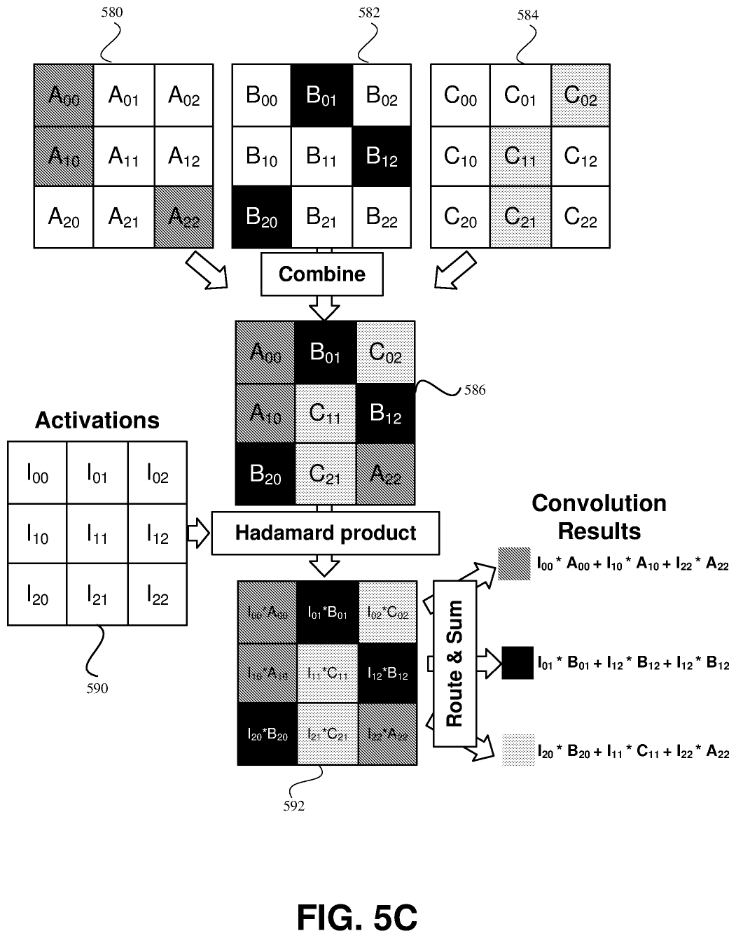

The weights and coefficients in activation functions of neural network may be adjusted by training and also be constrained by sparsity and structural requirements. Sparsity will be further discussed with reference to FIG. 2C through 2F and example structural requirements will be further discussed with reference to FIGS. 4A, 4B, and 5B. Training of neural network 200 may include forward propagation and backpropagation. In forward propagation, neural network 200 performs the computation in the forward direction based on outputs of a preceding layer. The operation of a node 210 may be defined by one or more functions, such as linear operation 224 and non-linear activation 226. The functions that define the operation of a node 210 may include various computation operations such as convolution of data with one or more kernels, pooling, recurrent loop in RNN, various gates in LSTM, etc. The functions may also include an activation function that adjusts the output of the node.

Each of the functions in neural network 200 may be associated with different weights (e.g., coefficients and kernel coefficients) that are adjustable during training. After an input is provided to neural network 200 and passes through neural network 200 in the forward direction, the results may be compared to the training labels or other values in the training set to determine the neural network's performance. The process of prediction may be repeated for other samples in the training sets to compute the overall value of the objective function in a particular training round. In turn, neural network 200 performs backpropagation by using gradient descent such as stochastic gradient descent (SGD) to adjust the coefficients in various functions to improve the value of the objective function.

Multiple rounds of forward propagation and backpropagation may be performed. Training may be completed when the objective function has become sufficiently stable (e.g., neural network 200 has converged) or after a predetermined number of rounds for a particular set of training samples. The trained neural network 200 can be used for making inferences or another suitable task for which the model is trained.

FIG. 2C through 2F illustrates the concept of sparsity in a neural network 200, according to various embodiments. Each of FIGS. 2C, 2D, 2E, and 2F shows the operation within a node 210 with different degrees of sparsity and is a graphical illustration of the flowchart shown in FIG. 2B. A circle in FIGS. 2C, 2D, 2E, and 2F represents a value in a tensor. In a neural network 200 with L hidden layers, the notation y^{l} denotes output activation tensor 228 from layer l and y^{l-1} denotes the output activation tensor 228 in the preceding layer l−1 or the input activation tensor 220 of layer l. W^{l} and u^{l} represent respectively the process tensor 222 and biases for each node. In a neural network node 210 that has a dense process tensor W^{l}, the feed-forward outputs are calculated as follow:

ŷ^{l}=W^{l}·y^{l-1}+u^{l} Equation 1

y^{l}=f(ŷ^{l}) Equation 2

where f is any activation function, such as tanh or ReLU and ŷ^{l} is the output of the linear operation before an activation function is applied.

The above relationship may be conceptually represented as a block diagram as illustrated in FIG. 2B. Graphically, a dense node with dense weights and a dense activation function such as tanh or ReLU is illustrated in FIG. 2C. In FIG. 2C, the result ŷ^{l} after the linear operation is dense with most of the values being non-zero. The active values (e.g., non-zero values) are represented by the shaded circles. The activation function also results in a dense output y^{l} in which a majority of the values are still active, which are also represented by the shaded circles.

Here, a value being active may refer to a value whose mathematical operation will need to be included in order to perform the overall computation. For example, in the context of matrix multiplication, convolution, or dot product, an active value may be a non-zero value because the mathematical operation, such as addition and multiplication, of the non-zero value will need to be included in order to get to the correct result of the matrix multiplication, convolution, or dot product. A value being inactive may refer to a value whose mathematical operation may be skipped. For example, in the context of matrix multiplication, convolution, or dot product, an inactive value is zero because the mathematical operation involving zero, such as addition and multiplication, may be skipped without affecting the final result. A process tensor is dense if the percentage of active values in the tensor exceeds a threshold. Likewise, an activation is dense if the activation function will result in a number of output values in the output activation tensor y^{l} being dense and the percentage of the active values exceeding a threshold. Using ReLU as an example, ReLU sets values that are lower than a level (e.g., 0) as 0 and allows values that are greater than the level to retain the values. Hence, it is expected that ReLU will generate about half active values if the values in the intermediate tensor ŷ^{l} are roughly equally distributed around the level. A tensor output that has about half of the values being non-zero is often considered as dense. In FIG. 2C, since the process tensor is dense and the activation layer will also generate a dense value, the node 240 can be considered as a weight-dense and activation-dense node 240, or simply referred to as dense-dense node 240.

The degree of sparsity for a tensor to be considered sparse may vary, depending on embodiments. In one embodiment, the number of active values in a tensor is fewer than 50% to be considered a sparse tensor. In one embodiment, the number of active values in a tensor is fewer than 40% to be considered a sparse tensor. In one embodiment, the number of active values in a tensor is fewer than 30% to be considered a sparse tensor. In one embodiment, the number of active values in a tensor is fewer than 20% to be considered a sparse tensor. The number of active values in a tensor is fewer than 15% to be considered a sparse tensor. The number of active values in a tensor is fewer than 10% to be considered a sparse tensor. The number of active values in a tensor is fewer than 5% to be considered a sparse tensor. The number of active values in a tensor is fewer than 4% to be considered a sparse tensor. The number of active values in a tensor is fewer than 3% to be considered a sparse tensor. The number of active values in a tensor is fewer than 3% to be considered a sparse tensor. The number of active values in a tensor is fewer than 2% to be considered a sparse tensor. The number of active values in a tensor is fewer than 1% to be considered a sparse tensor. The number of active values in a tensor is fewer than 0.8% to be considered a sparse tensor. The number of active values in a tensor is fewer than 0.5% to be considered a sparse tensor. The number of active values in a tensor is fewer than 0.2% to be considered a sparse tensor. The number of active values in a tensor is fewer than 0.1% to be considered a sparse tensor. The number of active values in a tensor is fewer than 0.01% to be considered a sparse tensor.

FIG. 2D is a conceptual diagram that illustrates a sparse-dense node 250, according to an embodiment. Compared to the node 240 in FIG. 2C, node 250 has sparse weights that are illustrated by having much fewer connected lines. Despite being illustrated as a dense tensor, the input y^{l-1} can be a dense tensor or a sparse tensor, depending on the previous node's sparsity. The weights of this node 240 are sparse, meaning there are a large number of inactive values (e.g., zeros) in the process tensor. A sparse process tensor may be achieved by imposing a constraint on node 240 to limit the maximum number of active values in the process tensor. After the linear operation, the intermediate tensor ŷ^{l} is likely to be dense because the linear operation, such as tensor multiplication or convolution, likely spreads the number of active values in the tensor. After the linear operation, the non-linear activation 226 step is the same as the node 240 in FIG. 2C. For example, the ReLU activation function will get around half of the values as zeros. Overall, the output tensor y^{l} is still a dense tensor since about half of the values are dense. In this example, node 250 may be referred to as a weight-sparse and activation-dense node or simply sparse-dense node. The process tensors being sparse may be referred to as weight sparsity. Techniques and hardware architectures related to weight sparsity such as complementary sparsity are further discussed in FIG. 5A through 7B.

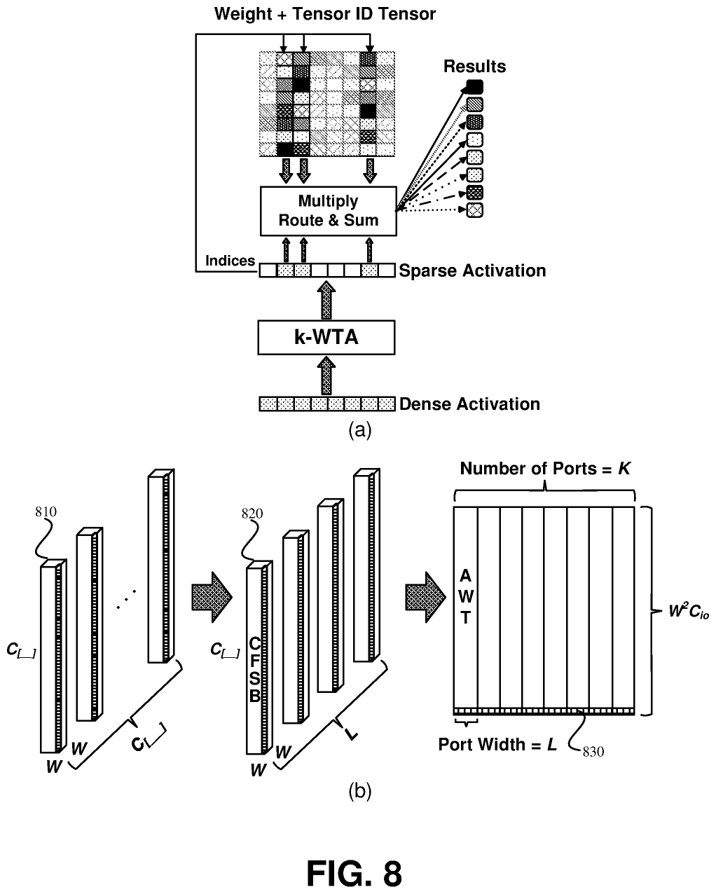

FIG. 2E is a conceptual diagram that illustrates a sparse-sparse node 260, according to an embodiment. Compared to node 250 in FIG. 2D, node 260 also has sparse weights, but it also has a sparse activation function that generates a sparse output. The input y^{l-1} can be a dense tensor or a sparse tensor, depending on the previous node's sparsity. In this example, the input y^{l-1} is illustrated as a sparse tensor. Even though the weights of this node 260 are sparse, after the linear operation, the intermediate tensor ŷ^{l} is likely to be dense because the linear operation likely spreads the number of non-zero values in the tensor. After the linear operation, a sparse activation function called K-winner activation is used instead of a dense activation such as ReLU activation function. K-winner activation selects the top K values in the intermediate tensor ŷ^{l} and force all other values, non-zero or not, to zeros. K may be a constraint set to maintain the sparsity of node 260 and may be set as a percentage of the total number of values in a tensor. For example, K may be 30%, 20%, 15%, 10%, 5%, etc., depending on the selection. The output tensor y^{l} is a sparse tensor after the K-winner activation function that restrains the number of active values in the tensor. In this example, node 260 may be referred to as a weight-sparse and activation-sparse node or simply sparse-sparse node. Using a sparse activation function in a node may be referred to as activation sparsity. Techniques and hardware architectures related to activation sparsity are further discussed in FIG. 8 through 12B. FIG. 2F is a conceptual diagram that illustrates a dense-sparse node 270, according to an embodiment. Node 270 has dense weights, but it has a sparse activation function that generates a sparse output.

Neural network 200 with one or more nodes that have the sparse-dense or sparse-sparse structure may be referred to as a sparse neural network. A sparse neural network may be a hierarchical temporal memory system. In various embodiments, while a sparse neural network may include a large number of sparse nodes, the sparse neural network may also include some dense nodes. Also, a sparse node may be a sparse-sparse node 260 or a sparse-dense node 250. In some embodiments, a node may also be with either weight sparsity or activation sparsity.

A sparse neural network often has improved performance in terms of speed in training and inference because the large number of inactive values in the network allows the network to skip many mathematical operations. For example, many common operations in neural networks, such as convolution and tensor multiplication, may be converted to dot products. Oftentimes a processor uses dot products to compute those operations in neural networks. Zeros in the tensors will significantly simplify the number of multiplications and additions needed to perform in a dot product. In many cases, sparse neural networks may model the structure of a human brain, which appears to also rely on a large degree of sparsity. Those sparse neural networks often not only have improved speed compared to dense neural networks but also increase inference accuracy particularly in the cases of noisy environments. For example, sparse neural networks reduce the number of parameters necessary to achieve an equivalent result accuracy, leading to savings in computational infrastructure, execution time, latency, power and therefore costs. They also exhibit increased robustness to noise in real-world situations. In Edge and IoT applications, a sparse network may fit on a limited deployment platform where an equivalent dense network would not.

### Example Circuitry for AI Accelerator

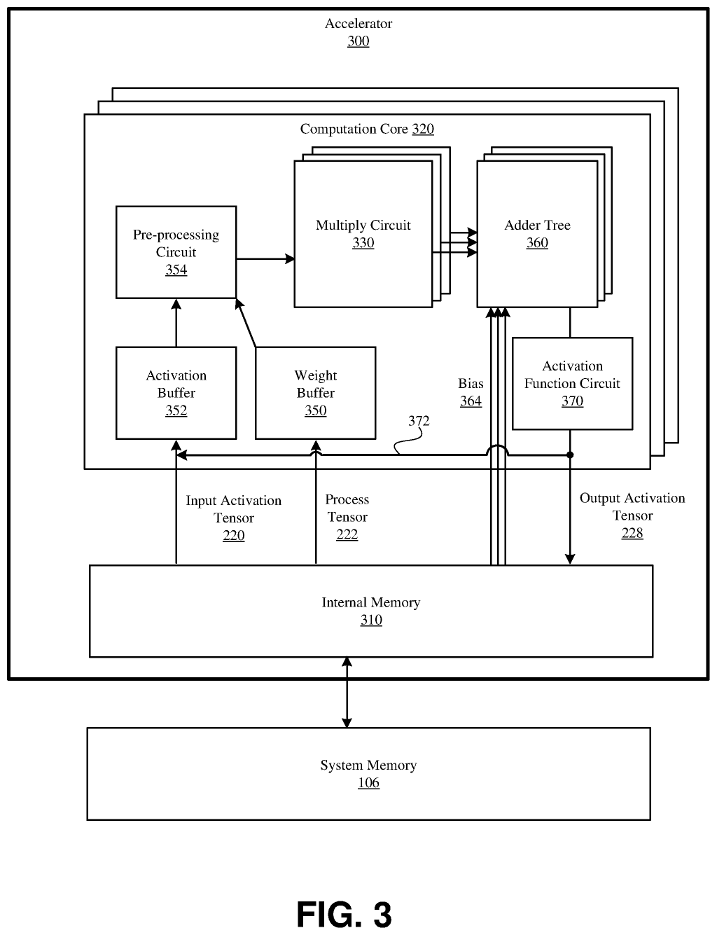

FIG. 3 is a block diagram illustrating circuitry and hardware architecture of an example accelerator 300, according to an embodiment. accelerator 300 may be a circuit that is efficient at performing operations related to a sparse neural network. Accelerator 300 may be an example of accelerator 104 or may also be embedded as part of a larger processor, such as CPU 102. In various embodiments, accelerator 300 may include fewer or additional components than the example shown in FIG. 3. For example, in one embodiment, accelerator 300 shown in FIG. 3 only illustrates blocks that are relevant to computations related to accelerating the operation of a sparse neural network and other components may not be shown. In one embodiment, accelerator 300 includes internal memory 310 and one or more computation cores 320 that perform computations in parallel.

Internal memory 310 may be the dedicated memory for accelerator 300 that is used for storage of data fetched from system memory 108 and data outputted by computation cores 320. The data stored in internal memory 310 may include input data of neural network 200, weights and other coefficients in neural network 200, intermediate data of neural network 200, such as output activation tensor 228 that is outputted by each node 210, loss function coefficients, and other suitable data that are related to the operation of neural network 200. For each node 210, input activation tensor 220 may be saved in internal memory 310. The input activation tensor 220 may be divided into multiple units and are sent to various computation cores 320 to process in parallel. The outputs of computation cores 320s may be recombined as output activation tensor 228, which is an output of a node 210. After the operations of the nodes 210 in a layer of neural network 200 are completed, operations of nodes 210 in the next layer may begin. The output activation tensor 228 is then fetched again to one or more computation core 320 as the input activation tensor 220 of a succeeding node 210 in the next layer. The process repeats until the operations reach the output layer 204. In some embodiments, the data stored in internal memory 310 may be sparse tensors that include zeros in various locations. In some embodiments, some data in internal memory 310 may also be compressed to dense tensors by removing zeros in the tensors. Compression of sparse tensors will be discussed in further detail.

In some embodiments, an accelerator 300 may not need to include internal memory 310. Instead, data are directly fetched and written to the system memory 108.

A computation core 320 is a circuit that performs computations between two or more tensors. The tensors may be a process tensor and an activation tensor. The computation core 320 may include a number of multiply circuits 330 that perform tensor operations such as the multiplications part of dot products, tensor multiplications, convolutions. Common machine learning operations such as tensor multiplications and convolutions may be converted to dot products and be performed by multiply circuits 330. A computation core 320 may include a number of multiply circuits for performing computations in parallel.

A multiply circuit 330 may take various forms. In one embodiment, a multiply circuit 330 is a multiply-accumulate circuit (MAC) that includes multiply units and accumulators. The multiply units may be used to perform multiplications and additions. A multiply unit is a circuit with a known structure and may be used for binary multiplication or floating-point multiplication. An accumulator is a memory circuit that receives and stores values from the multiply units. The values may be stored individually or added together in the accumulator. In some embodiments, the multiply circuits 330 may only include multiply units and perform elementwise multiplications.

Computation core 320 may include circuitry upstream of multiply circuits 330 for pre-processing of various tensors such as by dividing an input activation tensor into smaller units and by compressing and converting sparse tensors to a form that is efficient for the multiply circuits 330 to process. An activation buffer 352 is a buffer circuit and related data-processing circuit for performing data processing of an input activation tensor 220 for a node 210. For example, normally an input activation tensor 220 may have a size that is significantly larger than the capacity of a multiply circuit 330. The input activation tensor 220 may be divided into multiple data subunits and be processed in parallel by different multiply circuits 330. Activation buffer 352 may include circuitry that divides the input activation tensor 220 or include different addresses for various multiply circuits 330 to fetch different portions of the input activation tensor 220. In some embodiments, activation buffer 352 may fetch the tensor values from internal memory 310. In some cases, only the active values are fetched to activation buffer 352.

Activation buffer 352 may also perform a transpose operation of the input activation tensor 220 by fetching data values in the input activation tensor 220 in an order different from the order in internal memory 310. In some cases, an input activation tensor 220 may be saved in internal memory 310 under certain dimensions such as X by Y by Z while the division of data subunits may be more efficient under the dimension Y by Z by X. The efficiency of storage and operation of data under certain dimensions may depend on the hardware landscape such as the multiplier arrangement in a multiply circuit 330 and memory structure.

A weight buffer 350 and pre-processing circuit 354 are other examples of circuitry upstream of multiply circuits 330 for pre-processing of various tensors. For an operation with respect to a given node 210 in neural network 200, weight buffer 350 fetches the tensor values of process tensor 222 from internal memory 310 or system memory 108. Similar to activation buffer 352, in some cases weight buffer 350 may only fetch the active values in process tensor 222.

Pre-processing circuit 354 may include different types of circuits that are used to pre-process process tensor 222 and input activation tensor 220. Process tensor 222 and input activation tensor 220 may be associated with different degrees of sparsity. For example, in one case, process tensor 222 may be sparse while input activation tensor 220 may be dense. In another case, both process tensor 222 and input activation tensor 220 may be sparse. In yet another case, process tensor 222 may be dense and input activation tensor 220 may be sparse. Pre-processing circuit 354 may pre-process process tensor 222 and input activation tensor 220 in different ways, depending on their sparsity. For example, in some embodiments, process tensor 222 and input activation tensor 220 may be processed separately. In some embodiments, when both process tensor 222 and input activation tensor 220 are sparse, pre-processing circuit 354 may process the two tensors together.

In some embodiments, pre-processing carried out by the pre-processing circuit 354 may include identifying locations of active values in the process tensor 222 and input activation tensor 220. Pre-processing circuit 354 may scan through a sparse tensor and identify the locations of the active values in the sparse tensor. The locations may take the form of the locations in the tensor (e.g., a location at the third row and the fifth column in the tensor) and may also take the form of memory addresses of active values (e.g., an active value being saved in the memory address of 0xC0010000). Pre-processing circuit 354 may only transmit the active values to multiply circuits 330 for computations. In some embodiments, pre-processing circuit 354 may identify dense pairs that have active values at the same tensor location in both process tensor 222 and input activation tensor 220. Pre-processing circuit 354 may only transmit the dense pairs to multiply circuits 330 for computations. In other words, in some cases, pre-processing circuit 354 may exclude the transmission of inactive values in process tensor 222 or input activation tensor 220 to multiply circuits 330.

In some embodiments, pre-processing carried out by the pre-processing circuit 354 may also include compress a sparse tensor or combine multiple sparse tensors to a dense tensor. In various computations such as dot products and other multiplications, the results will be zero if one of the input values is zero. As such, the processing of those inactive values may be skipped in the multiply circuits 330. In some cases, when two tensors are multiplied, only multiplications of two active values are to be computed. As such, in some embodiments, pre-processing circuit 354 may compress a sparse tensor by converting the sparse tensor into a smaller-size dense tensor. In some embodiments, such as in complementary sparsity that will be discussed in FIG. 5A through FIG. 7B, pre-processing circuit may combine multiple sparse tensor that have non-overlapping active values to a dense tensor. In some embodiments, the compression or combination of tensors to generate a dense tensor may be performed offline and outside the accelerator 300 instead of at a pre-processing stage. The compressed or combined tensor may be stored in a memory such as the system memory. The number of multiplication operations to be performed by multiply circuits 330 may be significantly reduced after inactive values are removed from the tensors. By way of example, if a dot product is performed between two sparse tensors that each has about 10% of active values, it is expected to only 1% of the multiplication operations will need to be performed. The rest of the positions are either the multiplications of two zeros or multiplications of a non-zero value and a zero. By removing the inactive value (e.g., zeros) in the tensors, pre-processing circuit 354 may speed up the computations for multiply circuits 330. In some embodiments, the tensors fetched to pre-processing circuit 354 may also be structured so that pre-processing circuit 354 can remove the zeros in those tensors more efficiently. The structure of tensors will be further discussed in FIGS. 4A, 4B, and 5A.

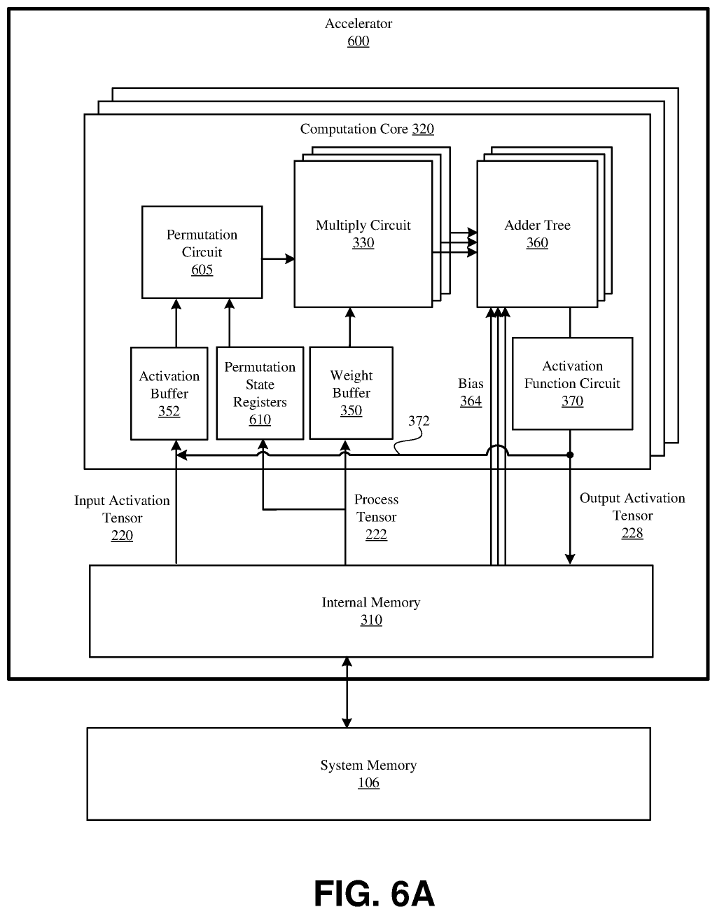

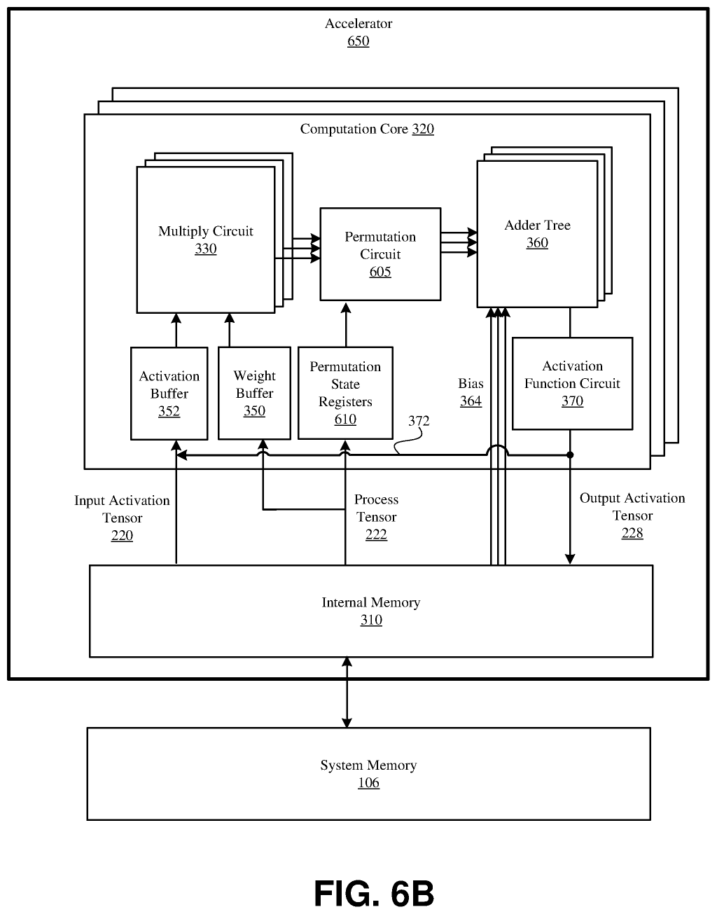

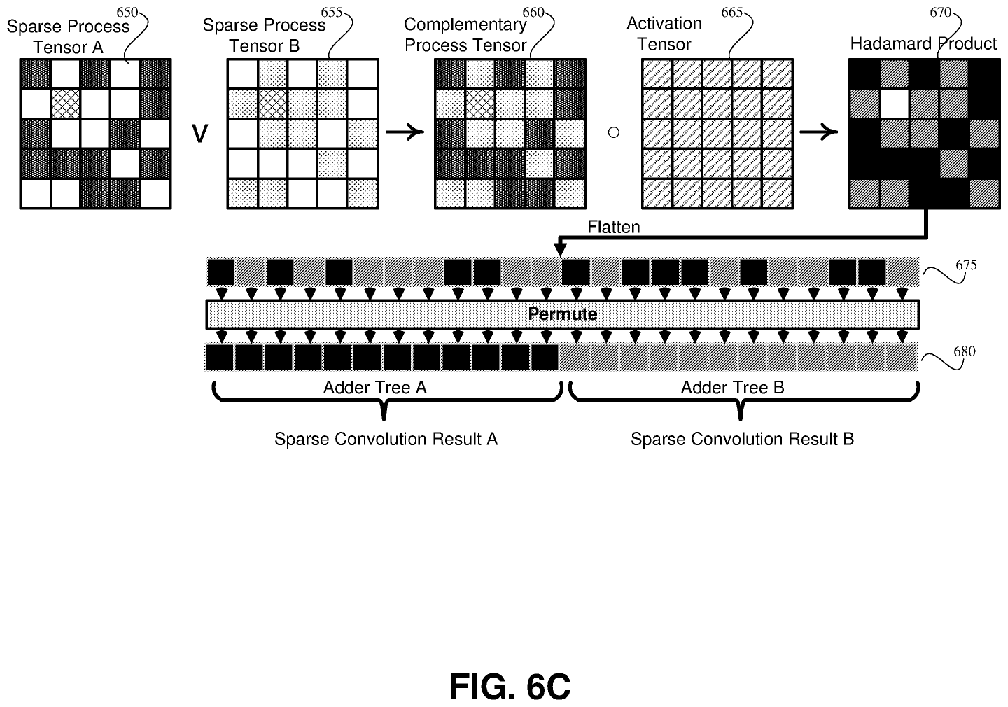

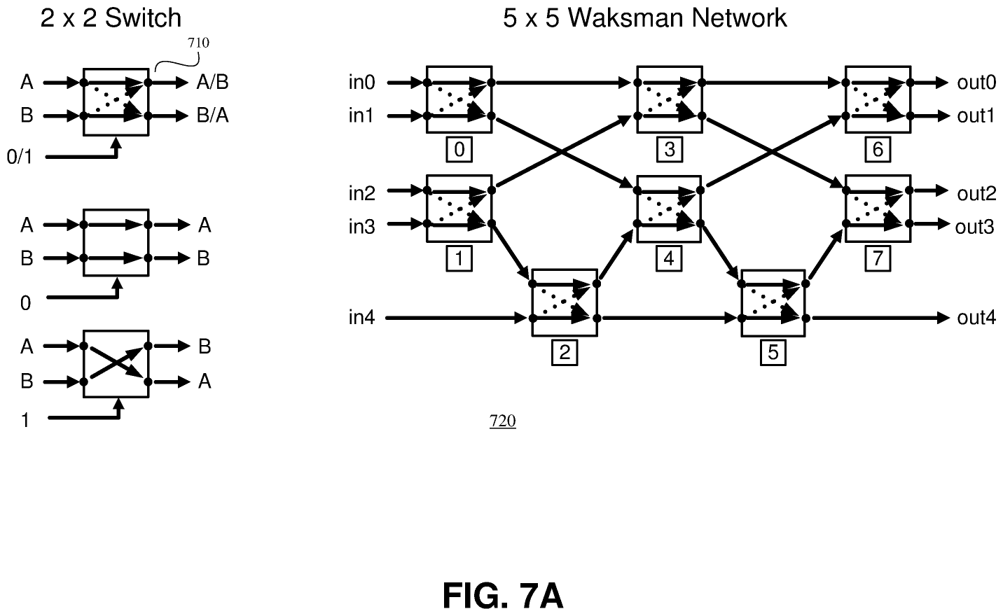

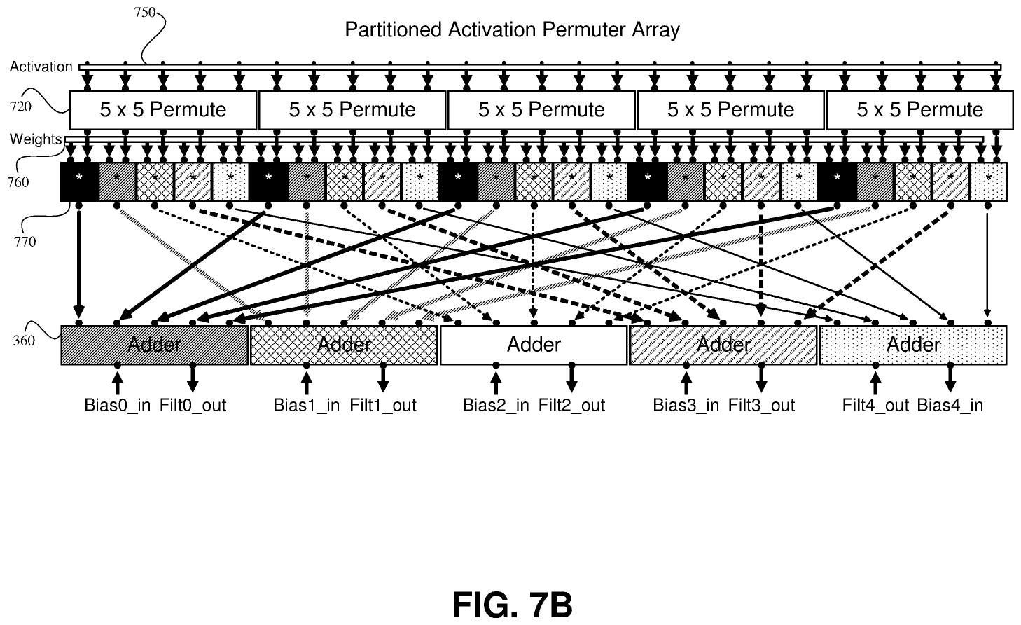

In some embodiments, pre-processing circuit 354 may also store the addresses of active values in the tensors so that the dense tensors and output tensors generated by multiply circuits 330 may be convert back to sparse tensors. For example, in complementary sparsity, multiple sparse process tensors may be combined as a dense process tensor. Pre-processing circuit 354 may use a state vector and tensor identifiers keep track of which locations correspond to which sparse process tensors. Pre-processing circuit 354 may function as a permutation circuit that re-routes and re-arranges values in various tensors so that values in a combined tensor may be grouped based on the corresponding sparse tensors. Example structures and operations of permutation circuits are further discussed in FIG. 6A through FIG. 7B.

Pre-processing circuit 354 may also perform other data pre-processing such as transposing process tensor 222 and input activation tensor 220. Pre-processing circuit 354 may also subdivide the tensors in a way that is efficient for multiply circuits 330 to process. The pre-processed tensors are fetched and sent to multiply circuits 330 to perform computations with input activation tensor 220.

After results of multiply circuits 330 are computed, the results are sent to one or more adder trees 360 to generate an intermediate output tensor ŷ^{l}. The results (products) of the multiply circuits 330 are then combined in adder trees 360. For example, in performing a dot product, multiply circuits 330 perform the multiplication and accumulation parts of the dot product and the results of different multiply circuits 330 are added together at the adder tree 360 to generate the final result. Alternatively, the accumulation parts may be performed in the adder tree, depending on the hardware architecture and the operations. In some embodiments, input activation tensor 220 is divided into multiple subunits for parallel processing in the multiply circuits 330. In some embodiments, for complementary sparsity, the products of the multiply circuits 330 are re-arranged by permutation circuits so that values corresponding to the same sparse process tensor are sent to the same adder tree 360. In some embodiments the computations performed on the sparse tensors are not multiplication and addition, but any pair of computations. In those embodiments, the multiply circuits 330 may be replaced by or reconfigured to a first computation circuit computing the first operator, and the adder tree may be replaced by or reconfigured to a second computation circuit computing the second operator. In some embodiments, the multiply circuits 330 (in FIG. 3 and other subsequent figures) may be referred to as a first computation circuit. The adder tree 360 (in FIG. 3 and other subsequent figures) may be referred to as a second computation circuit or a reduction tree. Likewise, the term “products” are not limited to multiplication products and includes any results of a computation.

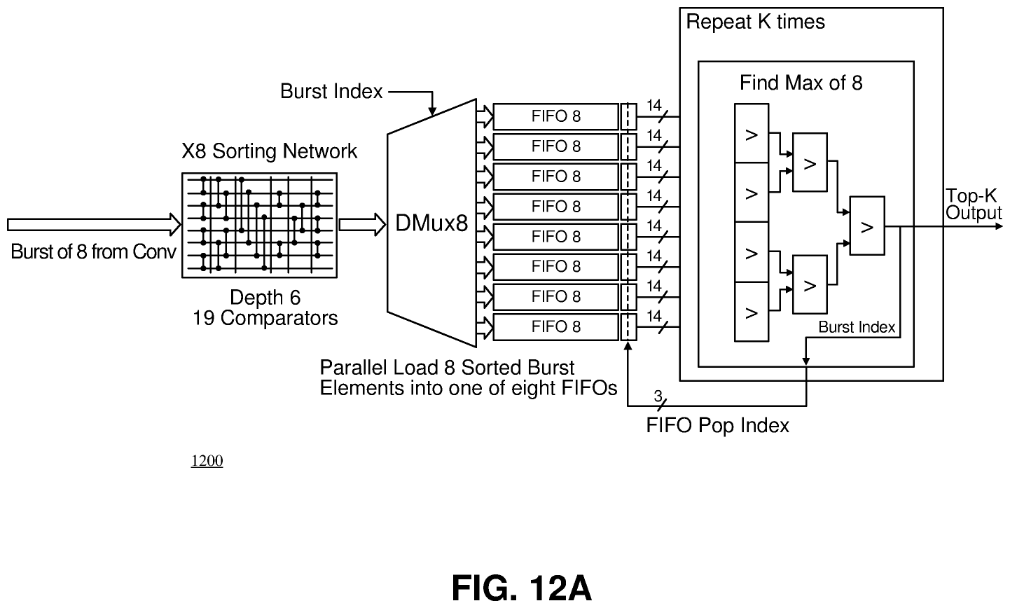

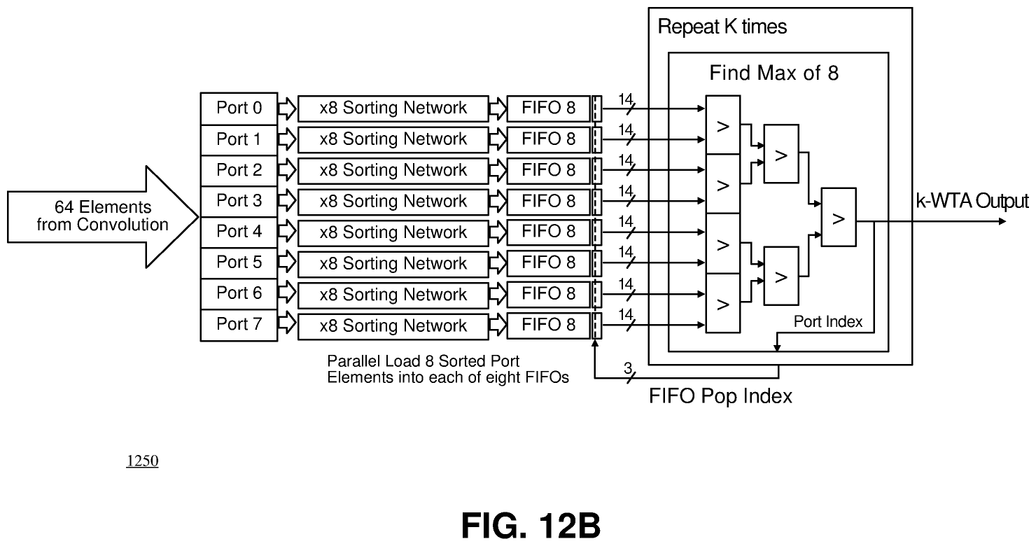

An activation circuit 370 is a circuit downstream of adder tree 360 to perform the operation specified in the activation function. Activation may be dense or sparse. Examples of dense activation include more conventional activations such as ReLU and tanh. Examples of sparse activation include K-winner take all (k-WTA) activation that will be discussed in further details. Activation circuit 370 may include a number of comparator circuits that are used for the ReLU activation function. Activation circuit 370 may also include comparator trees for determining top K highest values in a tensor in the case of a sparse K-winner activation function. Activation circuit 370 generates the output activation tensor 228 from the intermediate output tensor. Activation circuit 370 may set a number of values in the intermediate output tensor to zero, depending on the type of activation function. Hence, output activation tensor 228 may be a dense or sparse tensor. In some embodiments, one or more input tensors are previously compressed, activation circuit 370 may also expand the output activation tensor 228 back to the original size. Output activation tensor 228 is transmitted to internal memory 310 or system memory 108 as the output of a particular node 210. The output activation tensor 228 is fetched subsequently as input activation tensor 220 when another round of operations related to a subsequent node 210 begins. In some embodiments, the output activation tensor 228 may be directly sent within in the accelerator 300 as the input activation tensor of the next round, as represented by arrow 372. Example structures of the activation circuit 370 are further discussed in FIGS. 12A and 12B.

In some cases, bias factors 364 may also be fetched from internal memory 310. The bias factors 364 may be added or multiplied to some of the output values of some adder trees 360. For example, in some cases, boosting techniques may be used in association with a k-WTA activation. The k-WTA activation select the highest k output values among the nodes (or among a set or a partition) and set all other output values to zeros. In some cases, values corresponding certain nodes, such as nodes that are not selected in previous rounds of prediction or training, are manually boosted by increasing the output values. The boosting is used to increase the chances of some less frequently selected nodes to be selected in the k-WTA activation scheme. The magnitude of the boosting for each node may be a hyperparameter that is configurable or may be learned in the training.

The use of a sparse neural network and an accelerator that is efficient at operating with the sparse neural network reduces the number of computations and power consumptions of the accelerator. The sparse neural network also reduces storage requirements and working memory bandwidth. The accelerator improves the speed of a computing device and is suitable for use in computing devices that have limited power or computing capacity, such as IoT devices and in the case of edge computing.

### Example Structured Sparse Tensor Configurations

FIG. 4A is a conceptual diagram illustrating various examples of sparse tensors, according to an embodiment. Structured sparse tensors may be used as the data format of a sparse neural network. Such a format is efficient for an accelerator 300 to perform computations. For example, a properly structured tensor with active values arranged in a certain structured manner may allow pre-processing circuit 354 to process and compress the tensor in an efficient manner, thereby further speeding up the neural network.

Tensor 402 is an example unstructured tensor. Tensor 402 and various tensors in FIG. 4A are illustrated as 2-dimensional tensors with an x-direction (row) and a y-direction (column). In actual data, the tensors used in neural network 200 may include in any number of dimensions, from one to many. The discussions using 2-dimensional tensors may be extended to any number of dimensions. Whether a tensor is structured depends on whether the active values are distributed in any specific manner according to one or more constraints. According to an embodiment, the manners to arrange the active values may be referred to as block and partition. Each of those manners will be discussed in further detail in association with tensor 404 through tensor 438. In FIG. 4A, the active values (e.g., non-zero values) are represented by the shaded cells and the inactive values (e.g., zeros) are represented by the white blocks. In unstructured tensor 402, the active values are distributed randomly. For example, in the x-direction, the first row of tensor 402 has 4 active values; the second row of tensor 402 has 4 active values; and the third row of tensor 402 has only 1 active value. The active values in unstructured tensor 402 are generated based on the training of neural network 200 without any constraints imposed on how the active values should be placed.

The use of unstructured tensors in an accelerator 300 may significantly slow down the speed of operation due to the sparse marshalling problem in identifying the randomly located active values. As mentioned in FIG. 3, to speed up a sparse neural network, a sparse tensor may be compressed to a dense tensor so that the computations related to value locations that are zero are skipped. However, in an unstructured tensor 402 that has active values occurring without an easily identifiable pattern, an accelerator may need to spend significant resources and time to scan through the tensor to identify the locations of active values. The time for scanning through the tensor may sometimes even be longer than performing the tensor multiplication in a brute-force manner such as by performing multiplications of two sparse tensors on all data locations of the tensors without identifying the sparse locations.

The marshalling problem may be illustrated by an example. The expected number of multiply-accumulate operations for a sparse-sparse (both tensors are sparse) dot product is the product of the tensors' densities. In a 1600-element dot product, if the first tensor's density is 5% and the second tensor's density is 12.5%, the expected number of the multiply-accumulate operations between two active values is only 10. This represents 160 times of computation reduction. To realize this computation reduction, the sparse tensors may be distilled by pre-processing circuit 354 to eliminate the operand pairs that have an inactive value involved and keep only the mutually active operand pairs from each sparse tensor. This distillation process may be referred to as a sparse to dense compression. However, without specific structured tensors and circuitry, rendezvousing these mutually active pairs can be a challenging problem. Also, in an unstructured tensor, the positions of active values within a tensor usually do not follow an algorithmic pattern. During compression from a sparse tensor to a dense tensor, coordinates will need to be associated with the active values. There will be storage and performance overhead in an accelerator for accessing these coordinates. General hardware circuitry, whether conventional CPU, GPU, FPGA, or ASIC, may take a significant time to compare both tensors to determine the locations with active values in both tensors. The time or the hardware footprint needed to perform the searching may rival a dense operation that conducts the dot products in all 1600 locations by vector processing with single instruction multiple data (SIMD) units. The searching of those locations may be referred to as the marshalling problem.

According to an embodiment, the sparsity of tensors in a neural network 200 may be constrained so that the active values are spatially structured. For example, structured tensors may be achieved in the training of neural network 200 by imposing one or more constraints on how the active values are distributed. The tensors 404 through 438 illustrate two types of structure, which are referred to as block structure and partitioned structure. A tensor may also be in a combination of these two types of structures. In a block structure, a tensor may be divided into blocks, which are a group of data value locations in the tensor. In the block structure, the active values are concentrated in a subset of blocks, leaving the rest of the blocks completely inactive. In a partitioned structure, the tensor may be divided into sub-volumes. One or more constraints may be imposed equally on each sub-volume. For example, the number of active values in each sub-volume may be a fixed number so that the partitions have a balanced number of active values. The partitioned structure results in less variability of the sparsity, which in turn reduces the combinatorics of the marshalling problem. The constraints of blocks and partitions may be imposed on one or more dimensions of the tensor. A tensor may also have both the block and partitioned structures in one or more dimensions.

Tensors 404 through 438 illustrate various examples of structures in different dimensions, according to different embodiments. In tensor 404, the tensor is divided into blocks in x-dimension. Each block includes 1×4 value locations. Each block is either active or inactive. In an active block, at least one of the values is active. In an inactive block, all of the values are inactive. In tensor 406, the tensor is divided into partitions in x-dimension. Each row is a partition. A constraint is imposed on tensor 404 so that each row (each partition) has the same number (4) of active values. In tensor 408, both block structure and petitioned structure are imposed in x-dimension. Similar to tensor 404, tensor 408 is divided into 1×4 blocks. Each row in tensor 408 has one and only one active block, which is a condition imposed on the partition.

Tensor 412 through 438 illustrate additional structures that are in different dimensions and different combinations. For example, tensor 412 is a block structure in y-dimension. Tensor 414 is a block structure in both x and y dimensions. Each block includes 2×2 value locations. In tensor 416, block structure is imposed in y-dimension while the partition structure is imposed in the x-dimension. As such, each row (x-dimension) has four dense vertical blocks. Tensor 418 is divided by 2×2 x-y blocks. Partitioning is imposed in x-dimension so that each row in tensor 418 has 2 blocks. Tensors 422, 424, 426, 428, 432, 434, and 436 are additional examples of different combinations of block and partitioned structures. Tensor 438 is divided by 2×2 x-y blocks. Partitioning is imposed in both x-dimension and y-dimension so that each row in tensor 438 has 2 blocks. Each column in tensor 438 also has 2 blocks.

The block and partitioned structures can be applied to both input activation tensor 220 and process tensor 222. Each of the input activation tensor 220 and process tensor 222 may be blocked and partitioned in a similar manner but in different dimensions so that the pairing of input activation tensor 220 and process tensor 222 can predictably limit the number of computations. FIG. 4B illustrates several examples of such pairing of tensors. In operation 450, partitioned-x tensor 406 may represent the process tensor 222 and partitioned-y tensor 422 may represent the input activation tensor 220. The tensor 406 and tensor 422 both have a partitioned structure but the former has the partitions in a first dimension and the latter has the partitions in a second dimension different from the first dimension. Rows of tensor 406 and columns of tensor 422 have a fixed number of elements. Hence, operation 450 can have a maximum of 4 multiply-accumulate operations per dot-product.

In operation 460, block-x and partitioned-x tensor 408 may represent the process tensor 222 and block-y and partitioned-y tensor 432 may represent the input activation tensor 220. The tensor 408 and tensor 432 both have block structure and partitioned structure, but both blocks are partitions in different dimensions. In this case, rows of tensor 408 and columns of tensor 432 have a fixed number of blocks. Hence, operation 460 can have the maximum of 1 single instruction multiple data (SIMD) block multiply-accumulate operations per dot-product.

In operation 470, block-x and partitioned-xy tensor 428 may represent the process tensor 222 and block-y and partitioned-xy tensor 436 may represent the input activation tensor 220. The tensor 428 and tensor 436 both have block structure and partitioned structure, but the blocks are divided in different dimensions. In this case, both rows and columns of tensor 428 and the row and columns of tensor 436 have a fixed number of blocks. Hence, operation 470 can have the maximum of 1 single instruction multiple data (SIMD) block multiply-accumulate operations per dot-product.

### Example Complementary Sparsity Techniques

FIG. 5A is a flowchart depicting an example process 500 for performing operations related to complementary sparsity techniques in a sparse neural network, according to an embodiment. FIG. 5B is a conceptual diagram that graphically illustrates a sparse neural network operation using complementary sparsity techniques, according to an embodiment. FIG. 5A and FIG. 5B are discussed in conjunction with each other.

The process 500 may be performed by a computing device, such as computing device 100. The computing device may be equipped with an accelerator 300, 600, or 650 and may perform one or more steps of this process using the accelerator 300, 600, or 650. However, in some embodiments, the process may also be performed using a CPU, a GPU, or any combination of processors. The process may be embodied as software algorithm that may be stored as computer instructions that are executable by one or more processors and certain hardware architecture described in this disclosure may speed up the computation. The instructions, when executed by the processors, cause the processors to perform various steps illustrated in FIG. 5A.

The computing device initializes 505 a neural network with a plurality of nodes. The structure of the neural network may depend on its type, which can be CNN, RNN, LSTM, etc. The structures and operations of the nodes can be different among the nodes. The nodes may each be associated with a process tensor and an activation tensor. The structure and operation related to the tensors are discussed in FIGS. 2A and 2B. The initialized neural network may be saved in system memory 108 or storage unit 110. The process tensor in each node may include a plurality of data values. The initial data values may be initialized randomly or based on expected values. In some cases, the initial data values in the process tensor may be initialized with a number of zeros. In FIG. 5B, the process tensors are illustrated as sparse kernels 540, 542, 544, 546, and 548 and the activation tensor is illustrated as an activation matrix 550. The sparse kernels 540, 542, 544, 546, and 548 may correspond to the weights of five different nodes. Without loss of generality, the process tensors and the activation tensor may be in any dimensions and sizes and are not limited to each as a 5×5 two-dimensional matrix. For example, the technique can be applied to convolutional kernels by overlaying multiple 3D sparse tensors from a layer's 4D sparse process tensor. Also, there can be more or fewer than five nodes in each layer of the neural network.

The computing device imposes 510 one or more structural constraints to limit the distribution of active values of the process tensor. The constraints may be based on one or more code instructions in training the neural network that defines the configuration of the neural network. In complementary sparsity, the constraints may include the locations of active values so that no two sparse process tensors within a subset contain an active at precisely the same location. In some embodiments, the constraints do not dictate the relative positions of the active values or the permissible sparsity levels except may be a minimum sparsity. Given the flexibility of the constraints, experimental results show that neural networks trained with the complementary sparsity constraints do not compromise on accuracy when compared to unstructured sparsity. In some embodiments, additional constraints may additionally be imposed. For example, one or more blocky or partitioned constraints may also be applied.

One or more structural constraints may also be imposed for an activation tensor by way of the K-winner activation function. Referring temporarily back to FIG. 2A, for the nodes in the input layer 202, the input activation tensor 220 may likely be a dense tensor because the input data is often data such as image data, speech data, etc. As such, a node in the input layer may be a sparse-weight, dense-activation node, or simply a sparse-dense node. After process tensor 222 and a K-winner activation function are applied, the output activation tensor 228 can be sparse. For example, the K-winner activation function can limit the number of active values in the output activation tensor 228 and force the loser data values to zeros. The output activation tensor 228 becomes the input activation tensor 220 of the next node. The next node can be a sparse-sparse node. The K-winner activation function may be used in both training the neural network that defines the configuration of the neural network and in inference. In situations that involve boosting that gives favor to nodes that are not activated in previous cycles by manually increasing the values of the nodes, boosting may be applied before K-winner selection.

While the K-winner activation function is described as an example of a sparse activation function, other sparse activation functions may also be used in various embodiments. A sparse activation function is an activation function that results in a sparse output. The activation function is applied to the computation result in a neural network node. For example, in the K-winner activation function, the number of active values in the output may be limited by K. Alternatively, or additionally, a threshold approach may be used as a sparse activation function. Values that are below the threshold are set to inactive (e.g., set to zeros). The threshold may be global or local, static or dynamic. The threshold is applied to an entire tensor in the global approach while the threshold is only applied to a certain subset of data (e.g., a block or a partition) in a local approach. In a static approach, a predetermined threshold value may be used. In a dynamic approach, a threshold value may vary based on factors to be determined during the training. For example, statistics may be performed on a set of values on the fly to determine a dynamic threshold cutoff to set some of the values to zeros.

The structure constraint for the K-winner approach for the activation tensor can be global or local. If K-winner is applied to an entire tensor, the K-winner approach may be referred to as a global K-winner. If K-winner is applied to a subset of the tensor, such as a dimension, a block, or a partition of the data, the K-winner approach may be referred to as local K-winner. The computing device may train 515 the neural network using one or more structural constraints. The computing device may use one or more processors, such as an accelerator 300, a CPU, or in combination, to perform different computations associated with training of the neural network. The training 515 may include forward propagation 520 and backpropagation 530. In forward propagation 520, the processor performs computations as defined by each node in the forward direction as illustrated in FIG. 2A. In one or more nodes, the computation may include a linear operation between an input activation tensor 220 and a process tensor 222 followed by a non-linear operation, as illustrated in FIG. 2B. In backpropagation 530, the processors may adjust the weight values in the process tensors using techniques such as coordinate descent and also based on the structural constraints imposed on one or more nodes.

In forward propagation 520, different operations may be performed based on the sparsity of a node. The operations may include combining sparse process tensors to a dense process tensor, multiply-accumulation, and post-processing of tensors. The computing device may combine 522 a plurality of sparse process tensors to a dense process tensor. FIG. 5B illustrates the use of complementary sparsity to combine the sparse process tensors 540, 542, 544, 546, and 548 to a dense process tensor 560. Since the active value patterns in the sparse process tensors 540, 542, 544, 546, and 548 are non-overlapping, the sparse process tensors 540, 542, 544, 546, and 548 can be combined as a single dense process tensor 560. The dense process tensor 560 may also be referred to as a complementary tensor. In various embodiments, while the active value patterns are non-overlapping, the inactive values of the combined tensors do not need to completely fill the dense process tensor 560. In other words, the dense process tensor 560 may have one or more inactive values, although the particular example of dense process tensor 560 shown in FIG. 5B is completely filled with active values. For example, temporarily referring to FIG. 6C, an example of a complementary tensor 660 has a cross-hatched block that represents an inactive value location that is common to the corresponding sparse tensors.

In the particular example shown in FIG. 5B, each of the sparse process tensors 540, 542, 544, 546, and 548 is 80% sparse. A set of 5 non-overlapping patterns of active values is overlaid to form a single dense process tensor 560. The number of sparse process tensors that can be combined scales proportionally with their sparsity. A constraint is that the non-zero elements in each set do not collide with each other. In some embodiments, however, it is not necessary that all the process tensors in a layer are non-overlapping. The constraint applies only to each set being combined. Using this 80% sparsity example, if a convolutional layer contains 20 channels, there can be 4 dense combined process tensors 560 each corresponding to a set of 5 sparse process tensors. The values in the sparse process tensors are non-overlapping within a set, but there are no restrictions across the 4 sets. In some embodiments, some of the nodes may be complementary in nature while other nodes are not. For example, some of the nodes may be dense nodes.

The computing device may control 524 the permutation logic of the combined dense process tensor 560. Since the dense process tensor 560 is combined from multiple sparse process tensors, the computing device needs to track the positions of values that correspond to different sparse process tensors. The computing device also routes the appropriate computation products separately for each output. Each dense process tensor 560 is associated with a state vector that controls the permutation logic to produce the grouping of the sparse process tensors. Collectively the dense process tensor 560 and the state vector can be described as an augmented process tensor. The organization of dense process tensor 560 (complementary tensor) computation may be performed before or after multiplication. For example, step 524 may be performed before or after step 526. In some embodiments, in a pre-multiplication routing, the processor lines up the values in the activation tensor 550 with the weights that are clustered into groups. The pre-multiplication permutation may be referred to as a gather operation. In some embodiments, in a post-multiplication routing of elementwise products, the processor may steer the elementwise products into groups. The post-multiplication permutation may be referred to as a scatter operation. The computing device performs either pre-multiplication routing or post-multiplication routing to segregate the product results and steer the product results toward independent adder trees to be accumulated.

The computing device may perform 526 elementwise operations between the dense process tensor 560 and the activation tensor 550. The elementwise operations may be multiplication operations to generate multiply products (e.g., Hadamard products) and may be performed in parallel by a number of multiply circuits 330 in parallel. Similar to the discussion of FIG. 3, the elementwise operations may simply be referred to as the first computation or a binary operation and the operations may be carried by the first computation circuit, of which the multiply circuit 330 is an example. Combining multiple sparse process tensors into a dense process tensor 560 reduces the number of operations and speeds up the process. Rather than serially multiplying a set of sparse process tensors (e.g., 540 through 548) to subsets of the activation tensor 550, sparse process tensors are interleaved into a single multiply operation with the entire activation tensor 550. The higher the sparsity for each sparse process tensor, the greater the number of sparse process tensors that can be multiplied simultaneously.

The computing device separates the elementwise products into different results 570, 572, 574, 576, and 578 based on the permutation logic. The processor may perform 528 accumulations of elementwise products that correspond to sparse process tensors 540 through 548. For example, the elementwise products of the multiply circuits 330 are aggregated in adder trees 360. Each accumulated result corresponds to an original sparse process tensor. As such, multiple sparse process tensors 540 through 548 are multiplied with the activation tensor 550 in a single multiplication operation through the dense process tensor 560 and the accumulated results, which correspond to results of different nodes, are separately generated. Similar to the discussion of FIG. 3, the accumulation operation may simply be referred to as the second computation and the operations may be carried by the second computation circuit, of which an adder tree 360 is an example. The second computation circuit may also include one or more reduction trees.

The computing device may also apply 529 activation functions to the accumulated results generated by the adder trees 360. The activation function may be a dense activation function such as ReLU or tanh. The activation function may also be a sparse activation function such as K-winner. The activation function may further be a sparse and structured activation function such as blocky K-winner or partitioned K-winner. Blocky K-winner may refer to a division of the tensor by blocks and selection of top K blocks. Partitioned K-winner may refer to a division of the tensor by partitions and selection of top K values in each partition. After completing the computations of a node, the processor may perform computations on a subsequent node in the forward direction of the neural network until an inference result is made. The inference result is compared to the actual label of a training sample.

In backpropagation 530, the computing device may adjust 552 the weight values in process tensors of various nodes under the structural constraints, such as the complementary sparsity constraints. For example, the weight values may be adjusted using techniques such as coordinate descent to change the values in directions that will more likely for the neural network to generate the correct inference result.

After the neural network is trained with training samples, the neural network may be used to make 535 inferences from actual samples. The inference may be performed using the steps described in the forward propagation 530. Since the sparsity distribution and the active values in a process tensor may be fixed during the training, the combination of multiple sparse process tensors 540, 542, 544, 546, and 548 may be performed offline as a preprocessing step. The inference is also accelerated because the trained sparse process tensors 540, 542, 544, 546, and 548 are combined as the dense process tensor 560.

FIG. 5C is a conceptual diagram that illustrates complemental sparsity techniques graphically using three 3×3 sparse kernels as an example, according to an embodiment. Again, the exact dimensions and sizes of the sparse process tensors (3×3 sparse kernels in this example) vary, depending on embodiments. In FIG. 5C, the active values in a tensor are illustrated as shaded blocks and inactive values are illustrated as white blocks. The computation of a forward propagation step may include five different steps, which may be referred to as “combine,” “multiply,” “route,” “sum,” and “activation.”

In the combine step, multiple sparse process tensors 580, 582, and 584, each having 33% sparsity in this example, are combined and overlaid to form a single dense process tensor 586. The active values in each of the sparse process tensors 580, 582, and 584 remain in the same positions in the single dense process tensor 586.

In the multiply step, each value in the combined dense process tensor 586 is multiplied with the corresponding value in the activation tensor 590 in elementwise operations to generate elementwise products (e.g., Hadamard products). The elementwise products may be represented as a tensor form 592.

In the route step, the appropriate elementwise products are routed separately for each output. For example, the elementwise products that correspond to the first sparse process tensor 580 are routed together based on the permutation logic in the state vector. Likewise, the elementwise products that correspond to the second sparse process tensor 582 and the elementwise products that correspond to the third sparse process tensor 584 are respectively routed together based on the permutation logic.

In the sum step, the routed products are aggregated to form a separate result that corresponds to each sparse process tensor. Each separate result is a result of a node in a layer of the neural network. The sum step is an accumulation step that may be performed by the adder trees 360.

In the activation step, one or more activation criteria may be applied to the results of those nodes, which are aggregated in the sum steps. The activation criteria may be ReLU, tanh, LSTM gates, or other common activation criteria in a dense activation neural network. In a sparse activation neural network, the activation criteria may be a form of K-winner. The values of the results of those nodes are compared and top K values are selected as the winners of an activation selection. Other values are set to zero.

### Example Circuitry for Complementary Sparsity

FIGS. 6A and 6B are block diagrams illustrating circuitry and hardware architecture of example accelerators that are designed for improving the performance of using complementary sparsity techniques, according to some embodiments. FIG. 6A illustrates an example accelerator 600 that performs pre-multiplication permutation. FIG. 6B illustrates an example accelerator 650 that performs post-multiplication permutation. Most of the circuit components are similar to those in FIG. 3 and those components are not repeatedly discussed. The circuitry for FIGS. 6A and 6B may be used for sparse-dense networks.

A group of permutation state registers 610 are added to the accelerator 600 and the accelerator 650. As discussed in association with the process 500, multiple sparse process tensors are combined into a dense process tensor. In making an inference after training, the combination and generation of the dense process tensor may be performed as a pre-processing step and the dense process tensor may be stored in a memory such as internal memory 310 or system memory 108. The permutation state registers 610 are used to store the state vector that tracks the permutation logic when combining multiple sparse process tensors into a sense process tensor. For example, the permutation logic may store the corresponding active values of sparse process tensors as a sequence of sparse process tensor identifiers.

The permutation circuit 605 performs the routing of values based on the permutation logic stored in the permutation state registers 610. In pre-multiplication routing, the permutation circuit 605 may be an example of the pre-processing circuit 354. In the accelerator 600, a gather operation may be performed as a pre-multiplication routing operation. In a pre-processing stage, the values in the dense process tensor stored in a memory such as system memory 108 may be saved based on the order of the sparse process tensors (e.g., the order of the nodes in a layer of the neural network). For example, the values in the dense process tensor may have been re-routed in a pre-processing stage so that the active values in a first sparse process tensor will go first, then the active values in a second sparse process tensor, and so forth, even though such an order is not the actual order of the values in the dense process tensor. To perform the elementwise operations, the permutation circuit 605 may re-route and group the values in the activation tensor stored in activation buffer 352 based on the corresponding permutation and ordering of the routed dense process tensor. Elementwise operations may then be performed between the routed dense process tensor and the routed activation tensor in multiply circuit 330. The elementwise products are already gathered and ordered based on a certain order of the nodes in the neural network. As such, accumulations may be performed separately for each node.

In the accelerator 650, a scatter operation may be performed as a post-multiplication routing operation. The activation tensor and the dense process tensor may be directly multiplied in an elementwise manner using the multiply circuits 330 without re-routing. Hence, for example, the dense process tensor 586 shown in FIG. 5C may be multiplied by the activation tensor without re-ordering. The elementwise products may be represented in a tensor form, for example, as tensor 592 in FIG. 5C. The permutation circuit 605 in the accelerator 650 is located downstream of the multiply circuits 330. Based on the permutation logic stored in the permutation state registers 610, the permutation circuit 605 re-arranges the order of the values in a routing circuit to break the values in the elementwise products into different groups. Each group corresponds to a sparse process tensor (e.g., corresponds to a node in a layer of the neural network).

Whether the pre-multiplication routing or post-multiplication routing is used may depend on embodiments. In some embodiments, if the multiplication operands are floating-point numbers, the pre-multiplication routing or post-multiplication routing consumes equal or similar resources. In some embodiments, if the multiplication operands are fixed-point numbers, pre-multiplication routing may be preferable, in which the values in the activation tensors are re-arranged. In fixed-point post-multiplication routing, the product values are often twice the width of the activation operand values, and therefore require twice the resources (e.g., multiplexors, wires) to re-route the values to group the values based on nodes of the neural network.

FIG. 6C is a conceptual diagram illustrating complementary sparsity techniques and a post-multiplication routing, according to an embodiment. FIG. 6C illustrates the combination of two sparse process tensors 650 and 655. The shaded blocked in the sparse process tensors 650 and 655 represent active values in the tensors and the white blocks represent inactive values. The cross-hatched blocks represent an inactive value whose location is common to both sparse process tensors 650 and 655. While in this example the sparsity is about 50% and there are two sparse process tensors, in various embodiments the sparsity and the number of sparse process tensors to be combined can be higher.

The two sparse process tensors 650 and 655 are combined to form a complementary tensor 660, which is multiplied with an activation tensor 665 in elementwise operations to generate an elementwise product tensor 670. The elementwise product tensor 670 has a white block that represents the location where both sparse process tensors 650 and 655 have an inactive value. The elementwise product tensor 670 is flattened to a linear array 675. The linear array 675 has the same order of values as the elementwise product tensor 670 and, hence, has the elementwise product values of both sparse process tensors 650 and 655 mixed. In flattening the elementwise product tensor 670, the processor, such as accelerator 650, may remove any common inactive position(s). For example, since the elementwise product tensor 670 contains a white block, the 5×5 tensor is flattened to a 1×24 array with one value removed. Additional values may be removed if more common inactive positions are presented. The linear array 675 is then re-arranged to form a permuted linear array 680 by the permutation circuit 605. Values in linear array 675 are routed to as groups based on the sparse process tensors 650 and 655. Each group can be sent to an adder tree for accumulation. Example circuitry of the permutation circuit 605 is discussed in FIGS. 7A and 7B.

The pre-multiplication routing may be carried out in a similar fashion illustrated in FIG. 6C but will be carried out on the activation tensor 665. The complementary tensor 660 may be generated in a pre-processing step that is routed and grouped. In other words, instead of having the order of values of the complementary tensor 660 shown in FIG. 6C, in pre-multiplication routing, the complementary tensor's values may be grouped like the values in the permuted linear array 680 and the complementary tenor may be flattened. In pre-multiplication routing, as the activation tensor 665 is generated (e.g., generated as the output of a preceding layer of the neural network), the activation tensor 665 is re-arranged by the permutation circuit 605 before the multiplication and may also be flattened.

### Example Permutation Circuits

FIG. 7A is a conceptual diagram illustrating example circuitry that may be used in the permutation circuit 605, according to an embodiment. The circuitry shown in FIG. 7A are examples of sub-units of a routing circuit. The subunits may be a switch circuit 710 and a permutation network circuit 720. In various embodiments, the actual routing circuit can be scaled by using a combination of one or more switch circuits 710 and one or more permutation network circuits 720 based on the size of the processor and anticipated tensor work unit size (e.g., size of a dataset in an operating cycle).

The switch circuit 710 is a simple circuit unit that maps 2 inputs to 2 outputs using a control bit. A first value of the control bit directs the switch circuit 710 to simply pass the 2 inputs to 2 outputs. The second value of the control bit directs the witch circuit 710 to swap the inputs. The permutation network circuit 720 is a combination of multiple switch circuits 710 in a particular order so that N inputs can be permuted in any order as N outputs. The example permutation network circuit 720 shown in FIG. 7A is a particular arrangement that allows 5 inputs to be permuted. In many embodiments, since values in an AI processor are often stored as bytes or multiples of bytes (e.g., floating-point (FP) 16, FP 32, etc.), a permutation network circuit 720 may be of the size that is configured to handle 8 bits. The number of switch circuits 710 needed for N×N permutation network circuit 720 may follow this pattern: ┌N*log 2(N)┐−N+1. The number of stages needed for N×N permutation network circuit 720 may follow this pattern: 2*┌log 2(N)┐−1. The control of the permutation may be based on a lookup table that sends control bits to various switch circuits 710 (e.g., 8 switches in FIG. 7A) in a permutation network circuit 720. The control of the permutation may be saved in permutation state registers 610 in FIGS. 6A and 6B.

The permutation network circuit 720 is less resource-intensive to implement the desired reordering than parallel operations that may be used to permute a vector into a particular order. The permutation network circuit 720, such as the Waksman network, takes multiple nodes and logic stages to effect a permutation. In some embodiments, the permutation circuit 605 may be subdivided into multiple smaller permutation networks. The number of subdivisions corresponds to the number of samples for each sparse kernel.

FIG. 7B is a block diagram that illustrates the circuitry 700 that may be used for pre-multiplication routing, according to an embodiment. The components of the circuitry 700 may be examples of the permutation circuit 605, the multiply circuits 330 and the adder trees 360 of the accelerator 600 illustrated in FIG. 6A. In FIG. 7B, the activation array 750 is flattened from an activation tensor (not shown) that may be generated from a preceding layer of the neural network or input data. The activation array 750 is flattened but has not been re-arranged yet. The weight array 760 is also flattened from a dense complementary process tensor (not shown) and has already been re-arranged so that values corresponding to different sparse process tensors are grouped. The generation of weight array 760 may be performed in a pre-processing step. While the size of process tensors and the activation tensor in this example is 5×5, the circuitry 700 may be expanded to any size without the loss of generality. In this example, the neural network is subject to a sparsity constraint in addition to complementary sparsity. The additional sparsity constraint in this example is partition sparsity. For example, the corresponding 5×5 dense process tensor in this example may be combined from 5 sparse process tensors with the partition constraint that each sparse process tensor has a single active value in each row.

The order of the values of activation array 750 is re-arranged by different permutation network circuits 720. In this example, the maximum length of activation array 750 is 25. In the particular example of circuitry 700, five different permutation network circuits 720 are included in the circuitry 700. In various embodiments, other numbers of permutation network circuits 720, such as a single one, may also be used. After the values in the activation array 750 are re-arranged, the values are multiplied with the weight array 760 in an elementwise fashion to generate elementwise products 770. The elementwise products 770 may be statically routed to the adder trees 360. As the example dense process tensor is combined from 5 sparse process tensors, the elementwise products 770 are routed to five adder trees 360.

The partition sparsity constraint may further improve the improvement of the neural network and the associated hardware. The process tensor is subject to a partition sparsity constraint so that the process tensor is divisible into five (or N for other sizes in other examples) different partitions. As such, smaller permutation network circuits 720, such as the one illustrated in FIG. 7A, that handle the re-arrangement of a smaller number of values may be used. In some embodiments, if a partition sparsity constraint is not added, instead of multiple smaller permutation network circuits 720, a large permutation network circuit may be used. However, the number of switch circuits 710 used in a permutation network circuit ┌N*log 2(N)┐−N+1 so the number of switch circuits 710 needed for a larger permutation network circuit is often higher than having multiple smaller permutation network circuits.

### Example Sparse Activation Processes

FIG. 8 is a conceptual diagram that graphically illustrates a sparse neural network process 800 using sparse activation, according to an embodiment. The sparse activation example illustrated is a K-winner take-all technique, but in some embodiments, other sparse activation methods may also be used. The process 800 may be performed by a computing device, such as computing device 100. The computing device may be equipped with an accelerator 300, 600, or 650 and may perform one or more steps of this process using the accelerator 300, 600, or 650. However, in some embodiments, the process may also be performed using a CPU, a GPU, or any combination of processors. The process may be embodied as a software algorithm that may be stored as computer instructions that are executable by one or more processors and certain hardware architecture described in this disclosure may speed up the computation. The instructions, when executed by the processors, cause the processors to perform various steps illustrated in FIG. 8.

For each of the K non-zero activation values in the activation tensor, the index of the value may be used to extract the relevant weight values, which are then multiplied in an elementwise fashion. The individual terms of the elementwise products are routed separately to compute the sums for each output channel.

To compute the operation efficiently, a preprocessing step that combines sets of sparse process tensors 810 into smaller sets of combined dense tensors may be used in a fashion described in FIGS. 5B and 5C. The combined dense tensors are associated with state vectors that include sparse tensor identifiers for the active weight values. The collection of the combined dense tensors and the state vectors may be denoted as augmented weight tensors (AWT). The complementary sparse tensors 810 are combined into a smaller number (L) of dense complementary sparse filter blocks (CSFBs) 820. The dense CSFBs 820 are examples of combined dense tensors. Each of these dense CSFBs is flattened into a one-dimensional column. The collection of the one-dimensional columns are concatenated horizontally into an AWT 830 that has K ports. In some embodiments, the construction of this multi-ported AWT 830 may be an offline process done once for each convolutional layer. In addition, in the AWT 830, each active weight value has a sparse tensor identifier (TID) co-located with the active value. The sparse tensor identifier flows through to each of the resulting product terms and is used for subsequent routing.

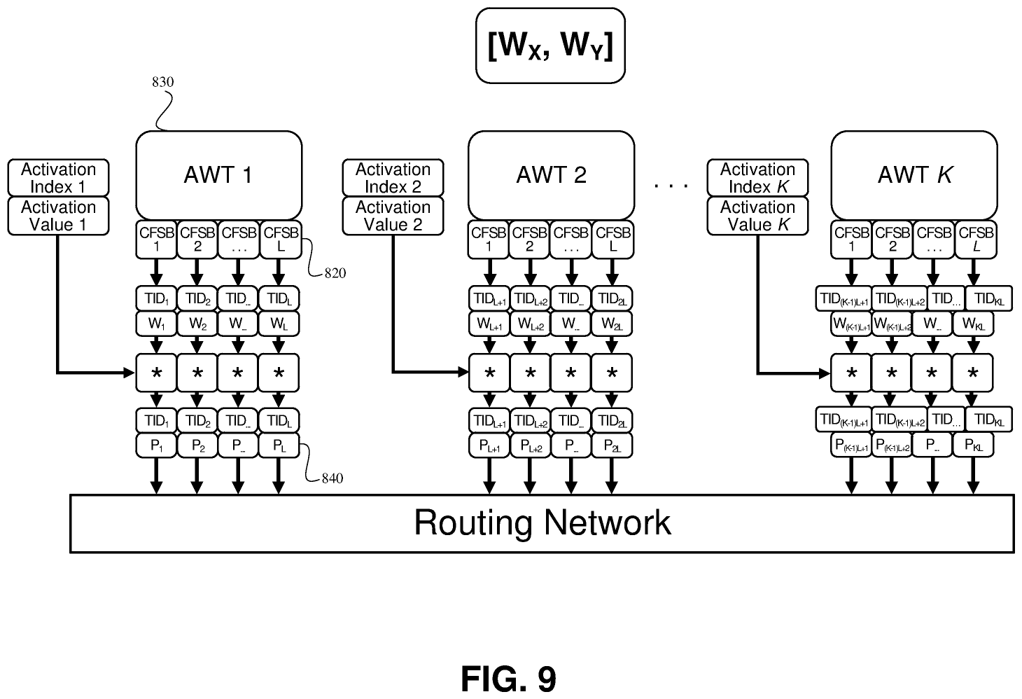

FIG. 9 is a conceptual diagram illustrating the fetching of augmented weight tensors 830 and multiplications between process tensor values and activation values, according to an embodiment. The operation of FIG. 9 may be implemented as circuitry that operates based on the principles illustrated below. In some embodiments, to compute the elementwise products, an accelerator may serially access the AWT 830, once for each of the K active values in the activation tensors. In some embodiments as illustrated by FIG. 9, K instances of the AWT 830 may be preloaded into a set of separate memories on an accelerator, which may be implemented as FPGA. Each instance of the AWT 830 may have a length L that includes L CSFBs 820. Each memory has multiple output ports that can support outputting L values at a time. Each output port of the memory delivers a value from each of the L CSFBs 820 in each AWT 830 in parallel. The activation-aligned weights can be read out in parallel from this multi-ported AWT 830. The activation values and the sparse tensor identifiers, TIDs, are also fetched from the memory. As a result, the elementwise products 840 for each column of the CSFB 820 can be computed in a single cycle. The sparse tensor identifiers flow along with the elementwise products 840 and are used for subsequent routing.

At inference time, the following formula generates the lookup address for the AWT 830, where (Wₓ, W_{y}) are the coordinates of columns in the CSFB 820, is the index associated with j'th non-zero activation value, and Cᵢₙ is the number of channels in the input activation tensor to the layer:

Address=Iⱼ+Wₓ*Cᵢₙ+W_{y}*Cᵢₙ*W Equation (3)

A scaling issue with this scheme is the amount of memory consumed by the complete AWT structure. The total number of bits for the multi-ported AWT 830 is:

B_{M}=Cᵢₙ*W²*K*L*B_{E} Equation (4)

Here, B_{E} is the size of each element and is the sum of the bit size of the weight element value, B_{W}, plus the bit size of the associated TID, B_{ID}. In some embodiments, 8-bit weights are used so B_{W}=8. To determine B_{ID}, the number of sparse tensors that can fit into a single CSFB 820 is calculated. The active weight values in each sparse tensor may be distributed using partitioned weight sparsity along the Cᵢₙ dimension. With N active values in each column of the sparse process tensor, the number of sparse process tensors in a single CSFB 820 is Cᵢₙ/N. Therefore, B_{ID}=[log 2(Cᵢₙ/N)]. If Gout is the number of output channels produced by the layer, the number of CSFBs 820 in an AWT 830, L, is equal to Cout/(Cᵢₙ/N). Plugging this into Equation (4) yields:

B_{M}=W²*Cₒᵤₜ*N*K*B_{E} Equation (5)

In some embodiments, the size of memory decreases as activation sparsity is increased (decreasing K). Similarly, the size of memory decreases as the weight sparsity is increased (decreasing/V). Therefore, the memory savings with weight and activation sparsity are multiplicative. Overall, with sparse-sparse networks, this approach of replicating weights enables far higher throughput with favorable memory scaling.

### Example Routing Operations in Sparse Activation

In some embodiments, an accelerator is further designed for efficient routing of the elementwise products from the elementwise operations. After an activation value is multiplied by a weight value, to complete the computation such as convolution, each resulting elementwise product is combined with the other products corresponding to the same sparse process tensor to generate an accumulated value. The relevant products are identified using the TIDs, which are copied and carried along with the computation, as shown in FIG. 9.

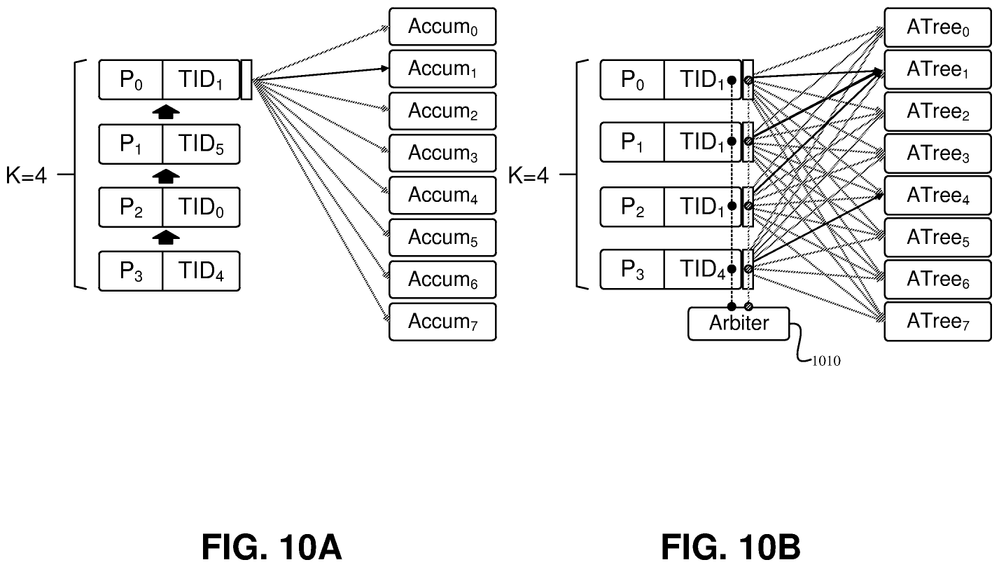

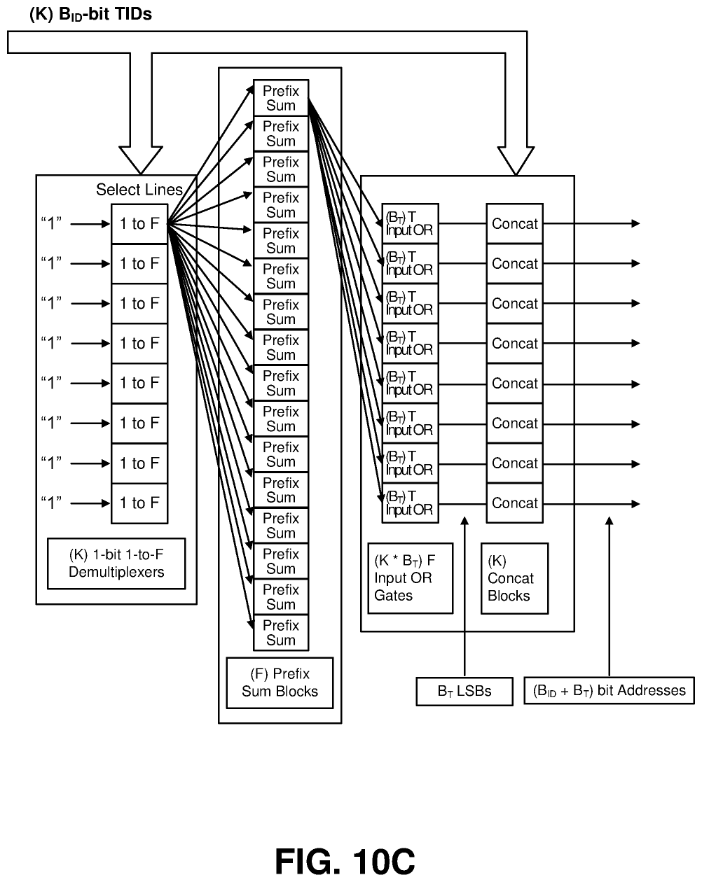

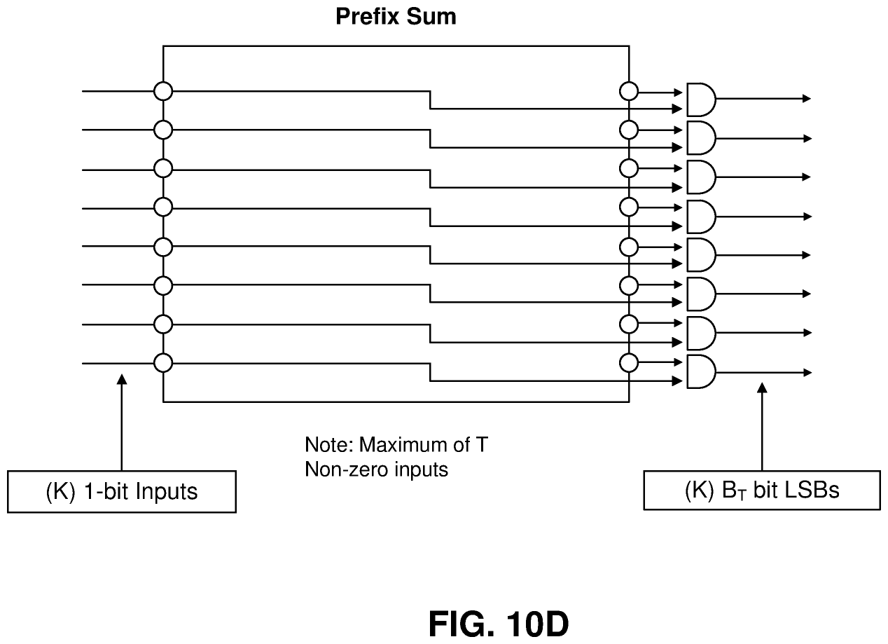

FIGS. 10A and 10B are conceptual diagrams illustrating two different ways of sparse-sparse product term routing using the sparse tensor identifiers, TIDs, according to some embodiments. The weight values in an AWT 830 may belong to a single sparse process tensor so that values have identical TID, or might be distributed across several sparse weights tensors that have different TIDs. Each of the K elementwise products can be processed serially, in which case the results for each of the products can be simply routed via a multiplexor network to a designated accumulator, based upon its Sparse Tensor ID. FIG. 10A illustrates that elementwise products are serially routed to the appropriate accumulator. The Pᵢ represent the product terms along with their associated TIDⱼ. The TIDⱼ are used to successively index a single multiplexer to route the product term to the relevant accumulator Accumⱼ to be summed. The solid black arrow indicates the selection process. This operation is performed serially K times.

FIG. 10B illustrates that elementwise products are routed in parallel to the appropriate adder trees. In some embodiments, for greater performance, the elementwise products can be processed in parallel. In FIG. 10B, the elementwise products are routed simultaneously to adder trees for summing, rather than to a single accumulator. To illustrate, the active routes are marked by solid black arrows. In the particular case shown in FIG. 10B, the three elementwise products P₀, P₁, and P₂ have identical TIDs of 1. As such, the elementwise products P₀, P₁, and P₂ are routed to ATree1. In some embodiments, the adder trees have the capacity to handle the possibility of all K product terms being routed to a single adder tree.

In parallel routing, routing of multiple elementwise products to non-conflicting inputs in an adder tree may introduce additional complexity. The parallel routing routes elementwise products based upon the TIDs. Additionally, destination address bits may be needed to designate the specific input port of the adder in which an elementwise product should land. This may be resolved with an arbiter 1010, which provides these additional address bits before the elementwise product is passed to a larger multiplexer network. This is indicated in FIG. 10B by a dotted line terminating on the arbiter 1010. The arbiter 1010 may generate low-order address bits from the set of TIDs, using a prefix sum algorithm. Each occurrence of an elementwise product with the same TID increments the value of the lower order bits so that elementwise products with the same TID are assigned to a non-conflicting slot in the adder tree. The generated low-order bits may be concatenated to the TID. The fine-grained fan-out to individual ports of the adder tree is not illustrated in FIG. 10B.

Various factors may be used to improve or adjust the efficiency of the computation. For example, in some embodiments, a partition sparsity constraint may be used. Sparsity partitioned in the channel dimension, as reflected in the range of TIDs, may reduce the bit size of the TIDs since only sufficient bits are needed to identify the sparse process tensor within the channel dimension, not the location within the W²*Cᵢₙ locations of a dense process tensor. Other factors that may affect the computation efficiency may include K and N. Small values for K, reflecting high activation sparsity, reduces the number of low order bits needed for adder tree input port assignment in the parallel implementation. Small values of N, reflecting high weight sparsity, also reduce the number of low order bits needed, since the number of product terms which can be directed towards a single adder tree is min(K, N).

FIG. 10C is a block diagram illustrating the structure of an example arbiter circuit 1010, according to an embodiment. The function of the arbiter circuit 1010 is to generate LSB address bits that are used to assign non-conflicting port addresses for each kernel filter's respective adder tree. In FIGS. 10C and 10D, K may be denoted as the number of non-zero activations and number of product terms being computed. F may be denoted as the number of filter kernels per CFSB. B_{ID} may be denoted as the number of bits to represent the range of F. B_{K} may be denoted as the number of bits to represent the range of K(┌log₂(K)┐). T may be denoted as the number product terms per filter kernel. B_{T} may be denoted as the number of bits to represent the range of T(┌log₂(T)┐).

The arbiter circuit 1010 generates the low order address bits from the set of K Tensor IDs (TIDs). Each occurrence of a product with the same TID effectively increments a count associated with that TID. This is done with a bit-wise prefix sum module for each TID, where the positions of the input “1” bits correspond to the storage order of the products and their TIDs. Referring to 10C, each of the K TIDs is fed into the select lines of a 1-to-F single bit demultiplexer. The inputs to the demultiplexers are tied to logical “1”, while the outputs of each demultiplexer is distributed to F instances of Prefix Sum circuits shown in FIG. 10D.

The K bits inputs to each Prefix Sum circuit are summed to produce a K*B_{T} bit wide output. FIG. 10D is a conceptual diagram illustrating a prefix sum circuit in the arbiter circuit 1010 shown in FIG. 10C, according to an embodiment. Note that the outputs are gated such that only inputs which have a “1” will produce non-zero B_{T} outputs. In some embodiments, the gating is used because in the next stage all F sets of LSBs generated in the prefix sum stage are logically “OR”ed together to produce a single K*B_{T} wide bit vector. In some embodiments, K*B_{T} OR gates are used, each with F inputs, one input from each of the Prefix Sum circuits. The K sets of BT bit-wide LSBs are paired and concatenated with the B_{ID} bits of their respective TID, completing the address generation function of the arbiter circuit 1010.

### Activation Sparsity Using K-WTA and Example Circuit Configurations

In some embodiments, for K-winner take all (k-WTA) techniques, activation sparsity may be induced by explicitly restricting the number of active output elements to the K largest values that are produced by a layer. In some cases, determining these top K values efficiently can represent a significant obstacle to the effective use of activation sparsity. The time and resources expended performing the sorting operation may erode the performance benefits associated with leveraging the resulting sparsity in subsequent processing. k-WTA implementations may fall into two broad categories. In a global k-WTA, all output elements in an output activation tensor are examined to determine the K largest to be selected and the rest to be set as zeros. In some embodiments, global k-WTA may be used in linear layers of a neural network. In a local k-WTA, the activation is partitioned into smaller units, and only the elements belonging to a partition are compared to each other. In some embodiments, local k-WTA may be used in convolutional layers of a neural network, where the winner-take-all competition happens along a specific dimension, such as the channel dimension. The process illustrated for determining k-WTA may be carried in the activation circuit 370.

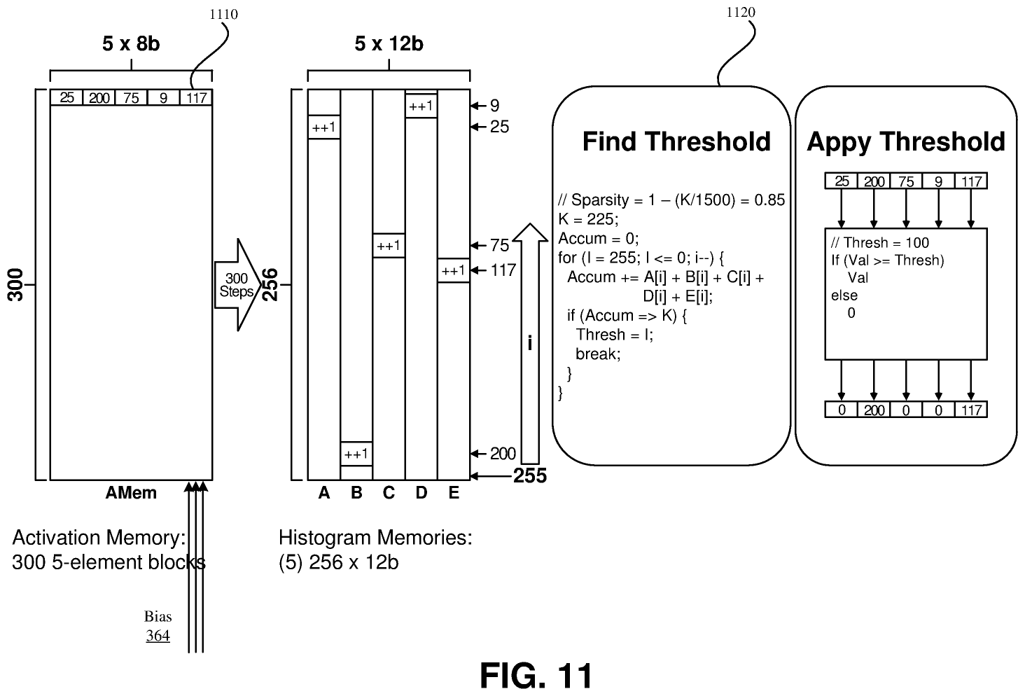

FIG. 11 is a conceptual diagram illustrating the circuitry of an example activation circuit 370 and the approach used for a parallel global k-WTA approach, according to an embodiment. The process performs a histogram-based search of the entire output to determine the threshold yielding K active output elements. The activation circuit 370 may include an activation memory 1110 that is used to store output values and histogram memories 1120 that are used to build a histogram that represents a distribution of the values of the output elements. Using 8-bit output values as an example, in some embodiments, a 256-element array in memory may be used to build the histogram, with each output value being used to increment a count at a location addressed by that value. After all of the output values have been processed, the histogram array represents the distribution of the output values. For a specified value of K, the histogram values can be read, largest first, to determine the appropriate minimum value cutoff. Output values above this threshold are retained as part of the top-k in the activation selection and the remaining output values are discarded. The activation circuit 370 may include a simple comparator circuit to compare the output values against the threshold. The winners are passed to the next layer as the activation values in an activation tensor for the next layer.

The activation memory 1110 may also receive biases 364 as shown in FIG. 3. In a boosting operation, output values that correspond to some of the nodes that are previously inactive may receive a boost in the values before the values are compared in the k-WTA operation. The boost may be a linear boost by adding a value to the output or a scaling factor that multiplies the output.

For improved performance, an implementation may process multiple output elements in parallel. In this scenario, multiple histograms are built in parallel and then combined to determine the overall cutoff value. An example of this implementation is illustrated in FIG. 11, for 1500-outputs, 5-way parallelism, and activation sparsity of 85%. In this example, the 1500-element output is stored as 300 5-element blocks in the activation memory 1110. Each block is read out and the element values are used to address and increment counts in 5 separate histogram memories 1120, A-E. The counts are then cumulatively summed into variable Accum, starting with the largest value location, until Accum reaches a total count of K, establishing a threshold value. Values in the activation memory 1110 are then compared to the threshold. The values are sent through to the next layer if the values are greater than or equal to the threshold, along with the corresponding indices in the original 1500 element vector. The specific numbers used in FIG. 11 are only examples. In various embodiments, other data sizes and sparsity levels may also be used.

FIGS. 12A and 12B are block diagrams illustrating example structures of sorting circuits 1200 and 1250 that are used for k-winner take all activation function, according to some embodiments. The sorting circuits 1200 and 1250 may be examples of the activation circuit 370.

The use of partition sparsity constraint may provide significant efficiency benefits in a sparse activation operation. In some embodiments, such as for convolutional layers, activation tensors and outputs may have a natural partitioning in the channel dimension. When the top-k operation in k-WTA is implemented as a sorting operation, which may have the complexity O(N*log(N)) either in time or hardware resources, partitioning may provide significant efficiency benefits. The position of each result value produced by the convolutional layer may be tracked through the sorting process. This is achieved by appending an index to each data value entering the sorting function.

In some embodiments, sorting may be performed in several stages. Since it is only needed to find the top K values in each set of output values, the ordering of the low-valued elements is immaterial. As K decreases with increasing activation sparsity, the cost of sorting implementation may fall accordingly. First, each set of output values may be subdivided into M sub-vectors. Each sub-vector is sent through a sorting network. The sorted sub-vector is subsequently loaded into one of M first-in-first-out (FIFO) circuits, with each sub-vector's largest value at the front of the FIFO queue.

A vector composed of the M top-of-FIFO values is then passed through a log₂(M) stage comparator tree, in order to determine the maximum value in the output set. The maximum value is retained, and its associated indexing information (which indicates in which FIFO the value was located) is used to pop that element from the appropriate FIFO, exposing the FIFO's next largest element. This process is repeated K times, at which point the output vector has been filled with the top K elements and is passed to the next processing layer. In some embodiments, a 64-element output set is subdivided into eight 8-element sub-vectors. The sorting network may include 19 comparators, arranged into depth 6 layers. There are 8 FIFO circuits, and a 3-level comparator tree is used to determine the maximum value in the 8-element top-of-FIFO vector.

To prevent bottlenecks, the performance of the k-WTA implementation may be matched to the performance of the convolutional operator. The incoming results can either arrive in serial bursts or as complete result vectors. A k-WTA implementation could wait until all bursts have been concatenated and a complete output result is available, or take advantage of the burst intervals and combinationally sort the burst values before loading the values into one of the FIFOs. FIG. 12A is a block diagram illustrating the sorting circuit 1200 for serially processing complementary sparse convolutions. Alternatively, all the activation results could be computed in parallel, partitioned into M groups, and pushed through M instances of a combinational sort before being loaded in parallel to the M FIFOs. FIG. 12B is a block diagram illustrating the sorting circuit 1250 for parallel processing complementary sparse convolutions.

Upon reading this disclosure, those of skill in the art will appreciate still additional alternative designs for processing nodes. Thus, while particular embodiments and applications have been illustrated and described, it is to be understood that the invention is not limited to the precise construction and components disclosed herein and that various modifications, changes and variations which will be apparent to those skilled in the art may be made in the arrangement, operation and details of the method and apparatus disclosed herein without departing from the spirit and scope of the present disclosure.

What is claimed is:

1. An accelerator for performing operations on tensors, the accelerator comprising:
a plurality of first computation circuits configured to perform first computations between values in a process tensor and values in an activation tensor to generate a plurality of products, wherein the values in the process tensor are associated with tensor identifiers;
a plurality of second computation circuits, each second computation circuit configured to receive a subset of the products that are grouped based on the tensor identifiers and perform a second computation for the subset of the products to generate an output value, the plurality of second computation circuits configured to generate a plurality of output values; and
an activation circuit coupled to the plurality of second computation circuits, the activation circuit configured to select a subset of the output values as winners of an activation selection and set remaining of the plurality of output values as zero.

2. The accelerator of claim 1, wherein the activation circuit is further configured to boost one or more output values of the plurality of output values before the activation selection.

3. The accelerator of claim 2, wherein the one or more output values that are boosted correspond to one or more nodes that are set to zero in a previous cycle of operation.

4. The accelerator of claim 1, wherein the activation circuit is configured to select a fixed number of output values as a number of output values in the subset that are selected as the winners.

5. The accelerator of claim 1, wherein the process tensor is a complementary dense process tensor that is combined from a plurality of sparse process tensors, and each of the tensor identifiers is used to identify one of the sparse process tensors.

6. The accelerator of claim 1, further comprising:
a routing circuit coupled to the plurality of first computation circuits, the routing circuit configured to:
carry over the tensor identifiers of the values in the process tensor to the plurality of products, and
divide the plurality of products into subsets based on the tensor identifiers; and

7. The accelerator of claim 6, wherein the routing circuit comprises an arbiter circuit that controls routing of a product of the plurality of products to one of the adder trees.

8. The accelerator of claim 6, wherein the activation circuit comprises a histogram memory that is configured to build a histogram that represents a distribution of the plurality of output values.

9. The accelerator of claim 6, wherein the routing circuit comprises a sorting circuit configured to select the winners from serial bursts of the output values.

10. The accelerator of claim 6, wherein the routing circuit comprises a sorting circuit configured to select the winners from the plurality of output values in parallel.

11. A method comprising:
performing first computations between values in a process tensor and values in an activation tensor to generate a plurality of products, wherein the values in the process tensor are associated with tensor identifiers;
grouping the plurality of products into a plurality of subsets of the products based on the tensor identifiers;
performing a second computation for each subset of the products to generate an output value, the plurality of subsets of the products generating a plurality of output values;
selecting a subset of the output values as winners of an activation selection; and
setting remaining of the plurality of output values as zero.

12. The method of claim 11, further comprising boosting one or more output values of the plurality of output values before the activation selection.

13. The method of claim 12, wherein the one or more output values that are boosted correspond to one or more nodes that are set to zero in a previous cycle of operation.

14. The method of claim 11, further comprising selecting a fixed number of output values as a number of output values in the subset that are selected as the winners.

15. The method of claim 11, wherein the process tensor is a complementary dense process tensor that is combined from a plurality of sparse process tensors, and each of the tensor identifiers is used to identify one of the sparse process tensors.

16. The method of claim 11, further comprising routing the plurality of products, wherein routing the plurality of products comprises:
carrying over the tensor identifiers of the values in the process tensor to the plurality of products, and
dividing the plurality of products into subsets based on the tensor identifiers; and

17. The method of claim 16, wherein routing the plurality of products is performed by an arbiter circuit that controls routing of a product of the plurality of products to an adder tree.

18. The method of claim 16, wherein selecting the subset of the output values as the winners comprises building a histogram that represents a distribution of the plurality of output values.

19. The method of claim 16, wherein routing the plurality of products is performed by a sorting circuit configured to select the winners from serial bursts of the output values.

20. The method of claim 16, wherein routing the plurality of products is performed by a sorting circuit configured to select the winners from the plurality of output values in parallel.
